(19) United States
(12) Patent Application Publication
(10) Pub. No.: US 2026/0332168 A1
(43) Pub. Date: Oct. 22, 2026

(54) ADAPTIVE MULTI-WAVEFORM GATEWAY

(71) Applicant: Tribalco LLC, Bethesda, MD (US)

(72) Inventors: Dalvez Owens, Bethesda, MD (US); Jose Galindo, Columbia, MD (US)

(21) Appl. No.: 19/184,833

(22) Filed: Apr. 21, 2025

(51) Int. Cl. H04B 1/00; H04B 17/309; H04L 9/40; H04L 12/66

(52) U.S. Cl. CPC H04B 1/0003; H04B 17/309; H04L 12/66; H04L 63/1416

(57) ABSTRACT

A gateway capable of dynamic, real-time adaptation, particularly in contested radio frequency (RF) environments. The gateway enables autonomous or semi-autonomous RF sensing, waveform adaptation, electronic warfare (EW) mitigation and propagation, and secure communication. The gateway can scan and assess a given RF environment and selects secure communication pathways. The gateway leverages machine learning (ML) and signal processing algorithms to optimize link performance, minimize detection probability, and ensure reliable communications across multi-band, multi-waveform networks. This can be achieved through a closed-loop feedback engine that monitors RF conditions, classifies threats, scores available waveforms and/or generates unique waveforms, and dynamically adjusts radio parameters with human input or without human intervention. The gateway can support both real-time and predictive optimization by combining time-series telemetry, trend modeling, and reinforcement learning techniques.

### BACKGROUND

Gateway devices have been used in telecommunications for decades. One problem with many available gateways is a lack of flexibility, often limited to using one set of protocols, such as internet protocols (IP), or proprietary protocols, such as those for programable radios used in law enforcement or military applications.

### SUMMARY

The present disclosure describes a gateway capable of dynamic, real-time adaptation, particularly in contested radio frequency (RF) environments. The gateway is designed around a software-defined architecture, enabling autonomous or semi-autonomous RF sensing, waveform adaptation, electronic warfare (EW) mitigation and propagation, and secure communication. The gateway can be implemented as a compact, modular, and intelligent payload deployable on unmanned aerial vehicles (UAVs), Intelligence, Surveillance, and Reconnaissance (ISR) platforms, or other mobile assets. The gateway can be implemented onboard such assets as a single edge compute node or in other suitable form factors and can offload various functions to a ground station or other device.

The gateway can employ systems and methods for scanning and assessing a given RF environment and intelligently selecting secure communication pathways. The gateway can receive and process communications from multiple paths, protocols, physical spectrums, or sources and process such inputs using software (e.g., middleware or one or more virtual machines (VMs)) to generate wide area network (WAN) output that can, in turn, be transmitted to multiple paths, protocols, physical spectrums, or destinations, including through custom waveforms chosen to avoid or minimize detection or interception. This is loosely known as an any-to-any capability, although the use of “any” is colloquial in that the goal is to be able to receive, process, and send data, practically, and there may be current or future data paths impractical for processing through the present gateway.

The gateway leverages machine learning (ML) and signal processing algorithms to optimize link performance, minimize detection probability, and ensure reliable communications across multi-band, multi-waveform networks. This can be achieved through a closed-loop feedback engine that monitors RF conditions, classifies threats, scores available waveforms and/or generates unique waveforms, and dynamically adjusts radio parameters with human input or without human intervention.

The gateway can support both real-time and predictive optimization by combining time-series telemetry, trend modeling, and reinforcement learning techniques. The gateway can interface with one or more software-defined radios (SDRs) or RF front end systems, support virtual IP routing, and integrate embedded cybersecurity protocols for hardened resilience in denied or degraded environments.

The present gateway can work alone or in combination with other disclosed components to perform the following selected or optional functions: a) adaptive waveform optimization based on live and historical RF telemetry; b) real-time spectrum analysis and smart frequency allocation; c) EW threat detection, classification, and counteraction; d) embedded intrusion detection and tamper response; e) role-based access control and encrypted waveform transport; and f) fully autonomous or semi-autonomous control with an operator-in-the-loop. Using such techniques or methods, alone or in combination, the gateway can accomplish the following selected or optional goals: a) secure and intelligent routing of data through algorithmic dissection and subsequent dissemination over one or more paths using one or more communication protocols or RF bands in a manner that avoids detection or interception, b) multicast distribution of data over one or more such paths using dedicated UDP port assignments, device registration, or other techniques allowing the gateway to recognize and address devices seeking to communicate with the gateway, c) providing SDR-based cellular or other wireless service in, for example, areas in which service has been disrupted, in which the SDR can be in a fixed location or mobile, including being affixed to a vehicle or configured for a human to carry; d) self-healing network management through ad-hoc peer-to-peer communication or other disclosed techniques, e) block chain encryption for symmetric or asymmetric key-based encryption of data communicated over such paths; f) block chain based communication using a multi-party protocol (MPP), a constellation protocol that uses multiparty computation (MPC), sharing consensus between n parties in a constellation, obviating central authorization, signature, or trust; g) optical transmission of data over one or more such paths using one or more lasers configured for secure and intelligent data transmission, h) synchronization management using either an onboard or separately-connected failsafe system atomic clock to provide precise position, navigation, and/or timing (PNT) information in instances in which global positioning satellite (GPS) or other synchronization signals are unavailable, degrade, or are otherwise unreliable.

The present gateway solves problems in conventional systems by using configurable hardware and software that allow the gateway to receive audio, video, control or other data streams from many different sources, protocols, physical spectrums, or communications technologies, extract a payload, and convert the payload to one or more formats for outgoing WAN output to a wide array of destinations, protocols, physical spectrums, or communications technologies. The gateway can be configured with an array of encryption technologies, SDRs, obfuscation techniques, self-healing techniques, and security systems. The gateway can be implemented as a standalone tactical node or integrate with broader networks and network devices, such as mesh, mobile ad hoc network (MANET), or IP-based networks, delivering cognitive radio performance with low size, weight, and power (SWaP) requirements. The gateway can be advantageous in environments inn which adaptability, survivability, and security are critical.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other.

FIG. 1 depicts a modular illustration of components of the present gateway.

FIG. 2 illustrates one example of a hardware diagram or schematic for the present gateway in which components of the gateway are in a single unit capable of onboard deployment.

FIGS. 3A-3O illustrate the gateway's various system processes using process blocks and data flows.

FIGS. 4A-17A illustrate sample algorithms (1-27) discussed herein.

FIG. 18 illustrates example interactions of the algorithms of FIGS. 4A-17A with the system data blocks of FIG. 3A.

### DETAILED DESCRIPTION

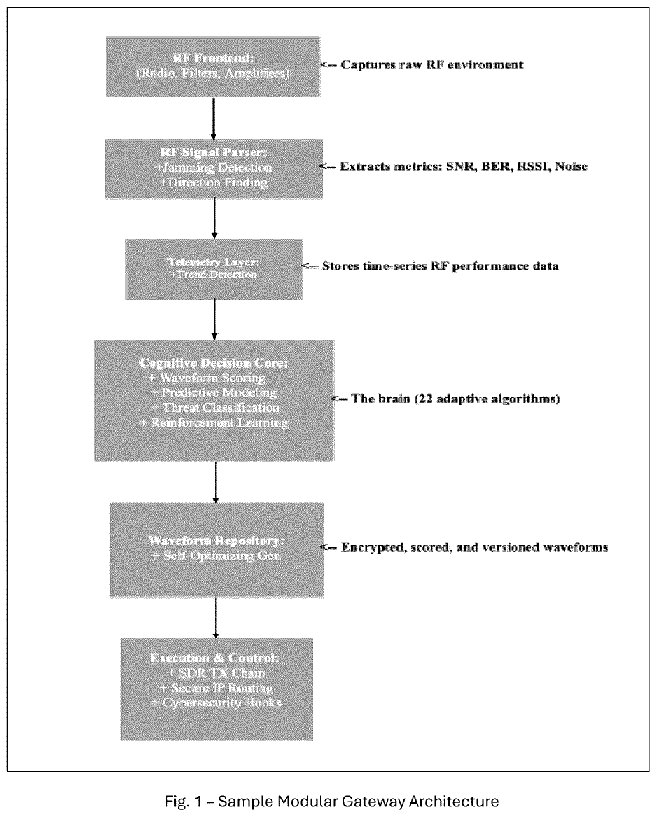

The present gateway architecture can be visualized as a series of modules, as shown in FIG. 1. Architecture, as abstracted in this block diagram, can consist of integrated modules organized into four primary layers: a) an RF front-end; b) signal processing and telemetry; c) a decision and adaptation engine; and d) a deployment/execution layer. A module can interact with another module over a secure interface, isolating, for example, real-time RF ingestion from decision-making logic, to achieve positive performance benefits, such as preventing signal spoofing or misclassification.

The first module, labelled RF Front End, can comprise the RF componentry needed to capture RF signals, including raw RF signals, thus capturing all or part of an overall RF environment. Such components will be known to one skilled in the art and, generally, comprise circuitry between a receiver's antenna or antennae, through and including a mixer stage, such as a radio, RF filter(s), RF amplifier(s), intermediate frequency (IF) filter(s), IF amplifier(s), demodulator(s), digital signal processor(s) (DSP(s)), and the like.

The second module, labelled RF Signal Parser, can comprise componentry such as a spectrum analyzer that can enable examination of the characteristics of an incoming RF signal, measuring signal amplitude across different frequencies to identify and parse incoming signals, interference, and other RF activity. In this module, metrics associated with RF signal quality can be extracted, such as signal-to-noise ratio (SNR), bit error rate (BER), received signal strength indicator (RSSI), noise levels, and the like. Using such metrics in this module, the gateway can assess the nature and quality of various RF signals in an overall RF environment and also make determinations such as identifying the presence of jamming technologies and assist with determining the direction from which particular RF signals emanate, thus allowing the estimation of direction to an RF radio emitter.

The third module, labelled Telemetry Layer, can comprise a software component capable of collecting, processing, and exporting telemetry data, such as logs, traces, events, and metrics, to understand the health, performance, and security of an RF environment. Analysis and visualization of the telemetry data can be done in this module or done partially or wholly in other backend or ground systems, discussed herein. The Telemetry Layer can be a software-centric module responsible for the continuous collection, preprocessing, and secure export of telemetry data across the RF, compute, and security domains of the gateway. Such processing can include structured and unstructured data such as RF signal metrics (e.g., RSSI, SINR, noise floor), system logs, algorithm trace points, performance counters, spectrum snapshots, and security events. While primarily implemented as a software stack, it can interface with hardware-based monitoring components such as SDR-integrated sensors, hardware timers, or platform health monitors to enrich the telemetry corpus. The module supports both local analysis (e.g., anomaly detection, jamming correlation, link degradation trend mapping) and secure export to backend or ground systems for visualization, long-term analytics, or strategic coordination. It includes standardized APIs and serialization formats (e.g., JSON, Protobuf, or STANAG) to facilitate integration with external systems while enforcing access control and data tagging policies.

The fourth module, labelled Cognitive Decision Core, can comprise a software component performing the cognitive processes involved in making decisions within the broader architecture. This module is responsible for evaluating an RF environment, applying relevant knowledge and reasoning strategies, and selecting one or more downstream courses of action as to outgoing RF signaling. In this module, many adaptive algorithmic processes, discussed below, can be used to: a) score various available waveforms, b) perform predictive modeling as to how a waveform may perform in the sampled RF environment, c) classify threats detected in that environment, and d) engage in ML and other learning to reinforce the quality of decisions made and strategies employed.

The fifth module, labelled Waveform Repository, can comprise an onboard or separately-stored collection of waveforms and waveform-related data. This module can receive data from the fourth module as to waveform scoring, versioning, and encryption.

The sixth module, labelled Execution and Control, can comprise a software component that is responsible for further downstream processing and, ultimately, RF output from the gateway. This can involve processes, such as, instructing SDRs as to the characteristics of a desired RF signal output, ensuring secure IP routing, and detecting and managing cybersecurity hooks that an attacker may be able to use to gain unauthorized access to or control over a gateway.

Among the modules, there are several notable possible data flow pathways. For example, data flows from the third module, the Telemetry Layer, to the fourth module, the Cognitive Decision Core, including, potentially: a) time-series data, sequential data points over time that can be indexed or listed in time order to identify patterns, trends, and relationships and can be involved in forecasting future values, and b) event triggers, mechanisms that automatically or semi-automatically initiate actions or workflows when the gateway detects that a specific event has occurred. Another data flow is from the fourth module to the fifth module, including potentially data as to the assessment of waveforms, their scoring relative to each other, and identifying potentially optimal or quasi-optimal waveforms for use in a particular RF environment. A further data flow is from the firth module to the sixth module, including potentially the delivery of signed and validated waveforms for use through an SDR for output from the gateway. The data flow points between modules can be protected to enhance security, including methods familiar to one skilled in the art, such as potentially the use of tamper detection and response, intrusion detection, and the like. Role-based access control (RBAC) processes that restrict access to resources within the gateway to components that require such access can be enforced at waveform deployment and algorithmic override layers. The gateway can enforce RBAC at critical layers to restrict waveform deployment and algorithm override actions to only authorized users, subsystems, or peer nodes. Before any waveform is deployed from the repository to the SDR output module, the RBAC engine can verify the requesting entity's role, trust level, and permissions based on mission policy and system configuration. This can ensure that only approved components can activate or transmit waveforms, preventing unauthorized or malicious emissions. Similarly, override commands such as forcing a waveform change, modifying algorithmic priorities, or bypassing failback logic are scoped to specific roles (e.g., mission controller, tactical admin) to prevent unauthorized control manipulation or lateral movement. RBAC enforcement is embedded at runtime and integrates with intrusion and tamper detection systems to trigger alerts or lockdowns if access policies are violated or circumvented.

The gateway, comprising the six exemplary high-level architectural modules described above or structured around another architecture one skilled in the art can employ to achieve the same or similar functions and results, enables numerous improvements over prior art RF systems, either alone or in combination.

In one aspect, the gateway comprises an adaptive waveform optimization engine, which can dynamically select and reconfigure waveforms in real-time or quasi-real-time based on live, recent, or stored RF environment metrics, including SNR, BER, RSSI, noise levels, and jamming activity. In this aspect, the gateway can implement scoring logic and machine learning inference to determine preferred or optimal waveforms, while introducing minimal latency.

In another aspect, the gateway comprises a multi-layered cognitive decision stack, which can combine heuristic rule sets, predictive modelling, trend-based analytics, and reinforcement learning to assist with decision-making. These processes can enable both proactive and reactive optimization across multiple time scales, such as instant, short-term, and long-term.

In another aspect, the gateway comprises a self-optimizing waveform generator, capable of synthesizing waveforms, including new waveforms, based on environmental feedback and historical success rates. In this aspect, the gateway can perform autonomous or semi-autonomous mutation and recombination of waveform parameters within operational constraints.

In another aspect, the gateway can respond to EW threats, including potentially identifying, classifying, and prioritizing EW threats, such as jamming, spoofing, and detecting anomalous patterns. In this aspect, the gateway can respond autonomously or semi-autonomously to such EW threats, including potentially using techniques such as frequency hopping, notch filtering, waveform switching, or geolocation cueing.

In another aspect, the gateway can hide or disguise its real communications so that they blend in with the background radio noise. This makes it much harder for outside systems to notice that anything is being transmitted at all. The gateway may perform this by adjusting how signals are shaped, when they are sent, and how much power they use, like whispering in a noisy room. The gateway may also change its behavior based on what is happening in the environment or share this strategy with other systems nearby to stay hidden together.

In another aspect, the gateway may can send out fake or misleading radio signals that look like important messages to trick enemy sensors. For example, these signals would not contain real mission data, rather they may be designed to distract or confuse anyone trying to listen in or track communication patterns. The gateway can decide when and how to send these decoys based on the situation, and can make them look very similar to real signals to increase their effectiveness. This helps protect real transmissions by drawing attention away from them.

In another aspect, the gateway can enable encrypted waveform transport and execution, processes by which waveforms are signed, encrypted, and version-controlled before deployment on the output side of the gateway. In this aspect, runtime waveform execution can be gated by tamper detection, role-based access, and embedded security policies.

In another aspect, the gateway can employ an integrated cyber-EW hardening layer, potentially including an Embedded Intrusion Detection System (EIDS), anti-tamper logic, and zero-trust access enforcement for all system components. In this aspect, cybersecurity features can be embedded at the signal processing, decision, and control layers, such that there is minimal or no reliance on external firewalls or endpoint protections.

In another aspect, the gateway can employ natural language prompting for semi-autonomous performance with a user-in-the-loop. This aspect can allow an operator to prompt the system using natural language (voice or text) for tasks such as status queries, waveform testing, or override requests. This aspect can ensure intuitive control without reducing overall system autonomy. In another aspect, the gateway enables cognitive resource allocation, such as actively reallocating central processing unit (CPU), memory, and radio processing priority based on task criticality, RF conditions, and algorithmic load. This aspect can enable parallel algorithm execution without degrading mission-critical throughput. In another aspect, the gateway can employ virtual IP injection and autonomous routing, such that a waveform or radio module can be assigned a virtual IP address with automatic route injection. This aspect can support seamless integration with IP-based tactical networks, cloud environments, or mesh overlays.

In another aspect, the gateway can employ a modular algorithm architecture, allowing the gateway to employ numerous algorithms (27 examples discussed below), which can be decoupled and modular, allowing for rapid deployment, replacement, or updating of individual modules without disrupting the entire system. This aspect can potentially support classified extensions or field-swappable logic updates for mission-specific variants. In another aspect, the gateway can employ tiered RF failback with pre-negotiated continuity to supports a multi-tiered RF continuity protocol that pre-negotiates waveform transitions across radio nodes. In this aspect, a radio node can potentially maintain a list of approved fallback configurations prioritized by mission policy, environmental constraints, and link stability forecasts. Such negotiation can occur proactively, before signal loss or degradation, ensuring rapid realignment with or without human intervention. The tiers may span different frequency bands, waveform classes, or modulation schemes, all abstracted under a unified fallback orchestration layer. Such mechanisms can preserve synchronization, routing consistency, and waveform integrity during transitions, which can be critical in high-mobility or EW-contested environments.

In another aspect, the gateway can employ syndicated learning across payloads (using a cognitive mesh layer), in which a payload instance can operate autonomously and still participate in a distributed intelligence mesh, sharing insights, RF metrics, and learned behaviors over RF or physical interfaces. In this aspect, algorithmic engines, including waveform scoring, jammer classification, or link prediction, can be partially federated and continuously enriched through cross-node data syndication. In this aspect, the gateway can support both live peer-to-peer sharing and asynchronous knowledge injection for disconnected operations, allowing nodes to benefit from collective learning even after reconnection. Also in this aspect, synchronization protocols can ensure model compatibility, data consistency, and security validation of shared inputs. The architecture in this aspect can create a self-improving fleet of cognitive payloads that can adapt faster as collective runtime exposure grows.

In another aspect, the gateway can employ dual-mode intelligence sharing, employing a cognitive mesh and MPC compatibility (Secure Intelligence Bridging Layer (SIBL)). In this aspect, the gateway can support adaptive intelligence sharing models depending on the trust profile of connected nodes. In this aspect, the gateway can rely on trusted or authenticated networks (e.g., internal fleet) and use a distributed adaptive radio engine (DARE) layer to share waveform performance, threat telemetry, and learned optimizations for real-time collective benefit. In untrusted or semi-trusted coalition environments, the gateway, in this aspect, can transition into a Multi-Party Computation (MPC) mode, perform joint computation of waveform compatibility, routing decisions, or interference response strategies without revealing sensitive internal models or telemetry. In this aspect, the gateway can ensure data sovereignty and compartmentalization by design, which can be structured as a dual-mode architecture to allow the gateway to operate securely across national boundaries, coalitions, and contested partnerships, without compromising either autonomy or operational security.

As discussed above, one embodiment of gateway architecture can consist of integrated modules organized into four primary layers: a) an RF front-end; b) signal processing and telemetry; c) a decision and adaptation engine; and d) a deployment/execution layer. A module can interact with another module over a secure interface, isolating, for example, real-time RF ingestion from decision-making logic, to achieve positive performance benefits, such as preventing signal spoofing or misclassification.

The first layer, the RF front end layer, is involved in data ingestion and can involve the RF componentry from an antenna through a mixer stage and can involve the components and subsystems described above. As shown in Table 1, below, this layer can be enabled with the following subsystems, to achieve the identified purposes, using the identified exemplary hardware components.

TABLE !

| Subsystems | Purpose | Example Components |
|---|---|---|
| SDR Stack | Capture RF signals | USRP, BladeRF, LimeSDR |
| RF Sensor Suite | Monitor spectrum, noise, | LNA, filters, directional |
| | jamming activity | antennas |
| Physical | Detect tamper, breach | Sensors, accelerometers |
| Security Layer | | |

Within the first layer, there is also algorithmic processing through software that can perform sensor fusion and multi-protocol integration. This functionality is primarily involved in enabling the gateway to dynamically bridge and manage communications across heterogeneous RF transport protocols using real-time telemetry and sensor fusion. As shown in Table 1B, below, this layer can be enabled with the following subsystems, to achieve the identified purposes, using the identified exemplary algorithmic components.

TABLE 1B

| Subsystems | Purpose | Algorithms Involved |
|---|---|---|
| Sensor Data | Collect telemetry from RF | Trend-Based RF |
| Ingestion | environment (RSSI, SNR, BER), GPS, | Optimization (3) |
| | IMU, and system health metrics | |
| Protocol Translation | Identify active RF transport protocols, | Waveform Scoring Engine |
| Engine | bridge communication standards, | (10), Adaptive Waveform |
| | manage data format conversion | Optimization (1) |
| Context-Aware | Select optimal RF transport path for | Failback Policy Engine (26), |
| Routing Engine | voice/data based on telemetry, link | Cognitive Resource |
| | health, and environmental conditions | Allocation (25) |
| Multi-Protocol Voice | Maintain seamless operator | Swarm Weight Adjuster (7) |
| & Data Manager | experience, manages session | |
| | persistence, QoS, and voice handoff | |
| | during RF transitions | |

The second layer, the signal parsing and telemetry layer, can perform RF parsing, telemetry logging, and threat monitoring. As shown in Table 2, below, this layer can be enabled with the following subsystems, to achieve the identified purposes, using the identified exemplary algorithmic components.

TABLE 2

| Subsystems | Purpose | Algorithms Involved |
|---|---|---|
| RF Parser | Extract SNR, BER, | Real-Time Spectrum Analysis |
| | RSSI, noise floor | (6) |
| Telemetry | Store environmental | Trend-Based RF Optimization |
| Logger | metrics locally | (3) |
| EW Sensor | Detect jamming & | Smart Jamming Detection |
| Engine | spoofing | (12), RF Fingerprinting (13) |

The third layer, the decision and optimization engine, or Cognitive Core, enables the gateway to perform its various functions, including waveform-related functions, such as optimization, scoring, and learning. It can be thought of as a brain for the gateway. As shown in Table 3, this layer can be enabled with the following subsystems, to achieve the identified purposes, using the identified exemplary algorithmic components.

TABLE 3

| Subsystems | Purpose | Algorithms Involved |
|---|---|---|
| Decision | Determine optimal | Adaptive Waveform |
| Engine | waveform and route | Optimization (1), Waveform |
| | | Scoring Engine (10) |
| Learning | Refine performance | Reinforcement Learning (4), |
| Engine | based on history | Automated Waveform |
| | | Testing (10) |
| DARE Layer | Aggregate peer | DARE Synthesizer (23), Swarm |
| | intelligence | Weight Adjuster (24) |
| Continuity | Execute failback & | Failback Policy Engine (26), |
| Manager | MPC modes | MPC Negotiator (25) |

The fourth layer, the execution and control layer, is the layer in which decisions can be operationalized and secured. As shown in Table 4, this layer can be enabled with the following subsystems, to achieve the identified purposes, using the identified exemplary algorithmic components.

TABLE 4

| Subsystems | Purpose | Algorithms Involved |
|---|---|---|
| Waveform | Stores signed & | Encrypted Waveform |
| Repository | encrypted waveforms | Transport (20) |
| Network Stack | Manages virtual IPs | Virtual IP Assignment, |
| | and routing | Route Injection (21) |
| Access | Enforces zero-trust, | Zero-Trust Role-Based |
| Control Layer | RBAC policies | Access (18) |
| Cybersecurity | Detects and responds | EIDS, Tamper Detection & |
| Layer | to threats | Response (19) |

Although the architecture described above is exemplary and should not be viewed as limiting, as one skilled in the art may envision other suitable architectures, there are certain aspects of the architectures described above that represent improvements, alone or in combination, in the context of an adaptive gateway. One aspect is the modular design of the algorithmic components, which renders them easily manageable or upgradable without unduly affecting system stability. Another aspect is the secure data flow pipelines between layers, such that there is little or no raw telemetry data exposed beyond ingestion unless policy allows. Another aspect is the presence of a DARE Layer to form a cognitive mesh, which is involved in improving collective learning speed, often increased exponentially over time. Another aspect is an MPC Negotiator that can auto-enable only in untrusted or coalition networks, creating a dynamic trust boundary. A further aspect is that the gateway can allow fully autonomous performance or semi-autonomous performance with “human-in-the-loop” operation based on deployment or mission profile.

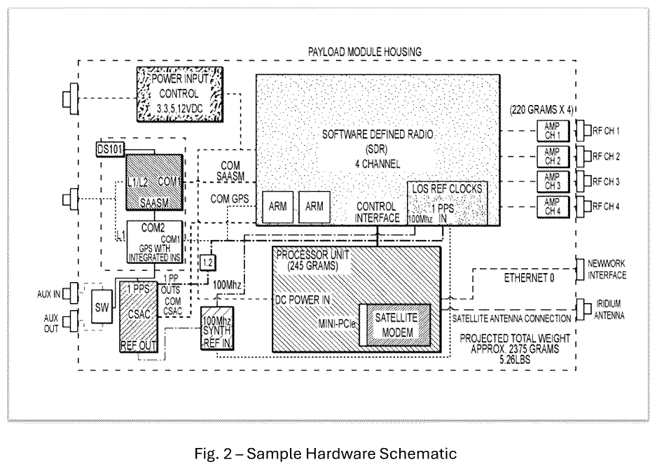

In one embodiment, the gateway can be optimized for specific environments. One example is for use in a high-altitude environment that may require that a gateway be hardened for temperature extremes, radiation, high gravitational forces (G forces), or other ambient or environmental factors or constraints. In such an environment, network topology may also allow for networking, whether peer-to-peer, mesh or other, among drones, balloons, or other suitable high altitude vehicles carrying gateways. For such environments, the present gateway may need to be light weight, such as less than or about five pounds in gross weight or meet weight constraints that the military or other users may impose. As shown in FIG. 2, for a wide array of environments or other constraints imposed, the present gateway can be reduced in size and weight such that components discussed throughout this application are available as a circuit board, custom chip, application specific integrated circuit (ASIC), or other form factor in which the gateway's components are reduced in size and weight or miniaturized. As shown in the example hardware diagram in FIG. 2, an SDR is associated with one or more processors, shown here as two Advanced RISC Machines (ARM) processors, but also potentially deployed using Intel, Nvidia or other processors, as examples only and not intended to limit the present invention. An ARM processor is one of a family of CPUs based on reduced instruction set computer (RISC) architecture and presently implement 32-bit and 64-bit RISC multi-core processors. RISC processors are designed to perform a smaller number of types of computer instructions so that they can operate at a higher speed, performing more millions of instructions per second (MIPS). By reducing instructions and optimizing pathways, RISC processors provide significant performance with less power than complex instruction set computing (CISC) devices. ARM processors are extensively used in consumer electronic devices such as smartphones, tablets, multimedia players and other mobile devices, such as wearables. Because of the reduced instruction set, ARM processors require fewer transistors, which enables a smaller die size for the integrated circuitry (IC). The ARM processor's smaller size, reduced complexity and lower power consumption makes them suitable for increasingly miniaturized devices.

In this example, an SDR with two onboard processors is connected to a SAASM (can be onboard or separately provided), chipscale clock, and a central processor (CPU) (optionally containing an onboard satellite modem or associated with a separate satellite modem), components needed for various connection pathways for the gateway to employ, including radio outputs and associated channel amplifiers shown on the right side of the Figure, pathways for 5G/4G LTE/3G and customized waveform communication, ethernet communication, and others), an optional onboard chip scale atomic clock (CSAC, such as a Microsemi SA.45s)) or a separately associated atomic clock, an optional satellite modem (such as an Iridium device), and appropriate power source and control components. By reducing the size and weight of the present gateway's components to board or chip scale, a wide variety of form factors and use cases can be addressed, including allowing the gateway to be more easily wearable or carriable by a user, including being embedded in clothing, a bag or backpack, or other appropriate form factor. Various embodiments of the present gateway can also be combined with a thermal or other self-destruction device, through which the gateway would render itself unusable under certain circumstances, such as interception or acquisition by an adverse party.

In other examples, the gateway can be deployed in a wide variety of contexts. As discussed, the gateway is designed with a modular hardware/software architecture to enable rapid deployment across diverse operational environments. Its low-SWAP requirements, cognitive engine, and secure communication capabilities make it nearly platform-agnostic. As shown in Table 5, there are numerous exemplary deployment modes, associated with numerous platforms, configurations, and use cases.

TABLE 5

| Deployment | | | |
|---|---|---|---|
| Mode | Platform Type | Configuration Characteristics | Use Case |
| UAV/UAS | Group 2-5 UAS, | Single embedded compute | Tactical ISR, Denied |
| Integrated | ISR Platforms | node; SDR(s); EW hardened; | Environments, Drone |
| Payload | | full autonomy enabled | EW Resilience |
| Dismounted | Manpack, Edge | Compact compute module; | Ground Team |
| Tactical Node | Compute in | SDR; ruggedized; operator UX | Communication, |
| | Pelican or | enabled | Operator-Controlled |
| | Wearable Config | | Spectrum Dominance |
| Mobile Command | Ground Vehicle, | Multiple SDRs; Central | Multi-node |
| Post Integration | Maritime, | Compute Stack; DARE-enabled | Coordination, |
| | Airborne Manned | fleet intelligence; Hybrid MPC | Network Control, |
| | Platforms | mode enabled | Coalition Ops |
| Airborne Relay/ | Manned or | High-altitude relay node: EW | Extended Network |
| Gateway | Unmanned | countermeasures prioritized; | Reach, EW Resistant |
| | Aircraft | multi-radio bridging | Comms |
| Static | Fixed Site, | Unlimited compute power; Full | Central Command |
| Infrastructure | Forward | telemetry logging; Centralized | Integration, Fleet |
| Node | Operating Base | waveform repository | Software Updates, |
| | | | Model Retraining |

Irrespective of the deployment mode, the gateway can maintain certain functions and capabilities that constitute improvements, alone or in combination. Such core attributes can include the Cognitive Engine, DARE layer, EW Threat Response, Secure Communications, including optional MPC Mode, and the described RF Failback Engine.

As multiple gateways can be deployed in concert, such as in the swarm UAV contexts discussed herein, scalability for a single gateway or multiple gateways is also addressed. In the interests of scalability, the disclosed gateway software architecture is containerized, thus allowing deployment on ARM-based SoCs (e.g., Jetson, Raspberry Pi CM4 and industrial equivalents), x86-architected devices, including so-called rugged compute devices (e.g., VersaLogic, ADDC, Kontron SBCs), or employing Cloud VMs for centralized control nodes (e.g., AWS GovCloud, Azure Gov). Likewise, the gateway's SDR interfaces are abstracted to allow the use of various SDRs. (e.g., Lime SDR, BladeRF Series, Ettus Research USRP Series, and, of course, future potential integration with other proprietary or classified radio). Further, the gateway's security postures are adjustable, accounting for RF and EW conditions in a particular environment. This means that the security posture can vary depending on many factors, including the trust level of network peers, the presence of coalition devices and associated identifiers, and tamper detection triggering various protective processes, as discussed herein and as known to one skilled in the art.

As discussed herein, the gateway can be deployed for operations in contested, congested, and denied environments. Its defensive posture can be configured to be proactive, autonomous, and layered, enhancing survivability of communications, system integrity, and mission continuity even under advanced EW or cyberattacks. As shown in Table 6, EW mitigation and response, as a framework, can include the following exemplary capabilities, achieving the following exemplary functions, employing exemplary algorithmic processes.

TABLE 6

| Capability | Functionality | Algorithms Driving Behavior |
|---|---|---|
| Smart Jamming | Identifies jamming attempts by analyzing | Smart Jamming Detection & |
| Detection | anomalies in modulation, energy spikes, or | Classification (12) |
| | pattern irregularities | |
| Adaptive | Automatically applies frequency hopping, | Adaptive Waveform |
| Waveform | bandwidth narrowing, or waveform | Optimization (1), Self-Optimizing |
| Response | mutation to mitigate detected jamming | Waveform Generator (5) |
| Dynamic Notch | Suppresses targeted narrowband jamming | Dynamic Notch Filtering (14) |
| Filtering | while preserving primary signal integrity | |
| RF Decoy | Enables the system to transmit adaptive, | Adaptive Waveform |
| Payload | deceptive RF signals designed to mislead | Optimization (1), RF |
| | adversary sensors, RF classifiers, or signal | Fingerprinting & Behavioral |
| | exploitation tools. | Analysis (13), Smart Jamming |
| | | Detection & Classification (12), |
| | | Trend-Based RF Optimization (3) |
| EW Threat | Real-time scoring of detected threats for | EW Threat Score Matrix (16) |
| Ranking | prioritization | |
| Direction | Locates RF interference or jamming sources | Direction Finding & Geolocation |
| Finding & | for operator awareness or kinetic response | Cueing (15) |
| Geolocation | | |
| RF | Identifies known hostile emitters by | RF Fingerprinting & Behavioral |
| Fingerprinting | signature | Analysis (13) |

Similarly, the gateway's cybersecurity capabilities are most challenged in contested RF environments. As shown in Table 7, cybersecurity mitigation and response, as a framework, can include the following exemplary capabilities, achieving the following exemplary functions, employing exemplary algorithmic processes.

TABLE 7

| | | Algorithms |
|---|---|---|
| Capability | Functionality | Driving Behavior |
| Embedded Intrusion | Monitors system processes and data flow for | EIDS (17) |
| Detection System | anomalous behavior or unauthorized access | |
| (EIDS) | attempts | |
| Zero-Trust Role- | Enforces strict access controls between system | Zero-Trust Role- |
| Based Access Control | modules and external connections | Based Access (18) |
| Tamper Detection & | Physical or logical breach detection triggering data | Tamper |
| Response | wipe, lockout, or countermeasures | Detection & |
| | | Response (19) |
| Encrypted Waveform | Ensures only validated, signed, and encrypted | Encrypted |
| Transport | waveforms are deployed | Waveform |
| | | Transport (20) |
| MPC Negotiator | Secure data computation and waveform negotiation | MPC Negotiator |
| | with untrusted or coalition nodes without data | (25) |
| | leakage | |
| Failback Policy | Secure pre-negotiated fallback waveforms triggered | Failback Policy |
| Enforcement | during cyber or EW compromise | Engine (26) |

As discussed above, and as identified as algorithmic components in the preceding tables, the gateway can employ numerous algorithms to perform its various functions. In various embodiments, one or more of the following 27 algorithms can be employed.

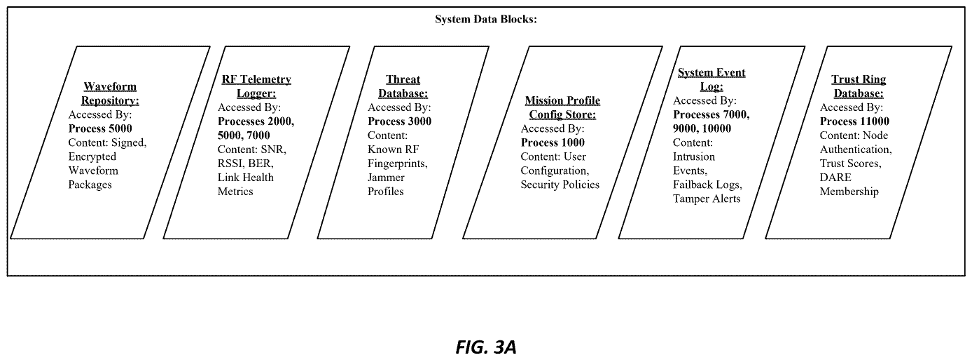

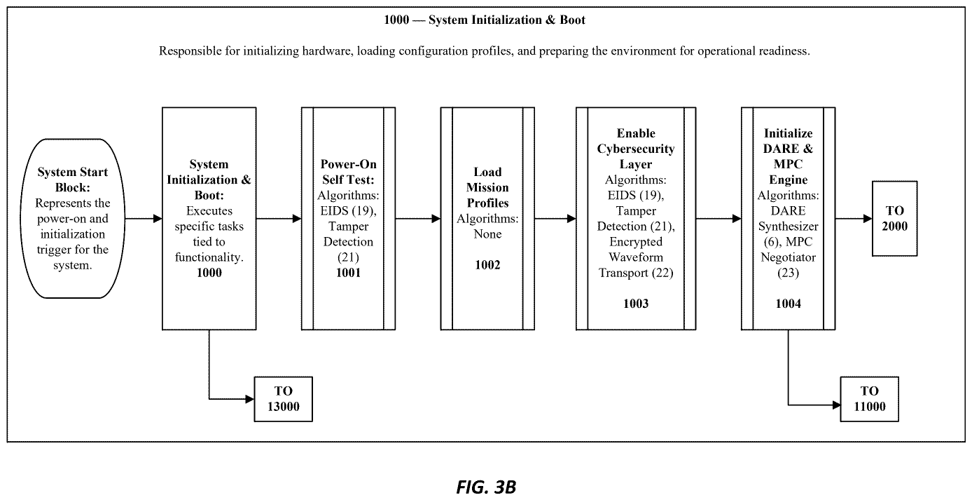

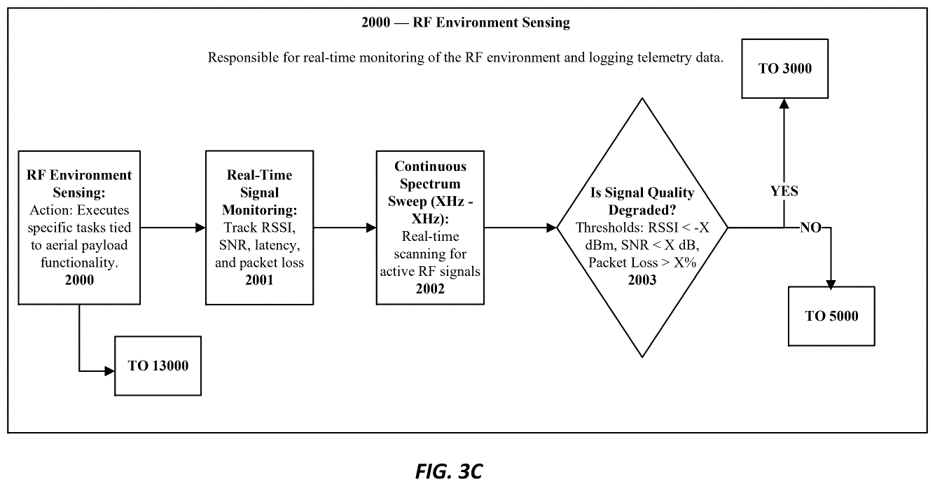

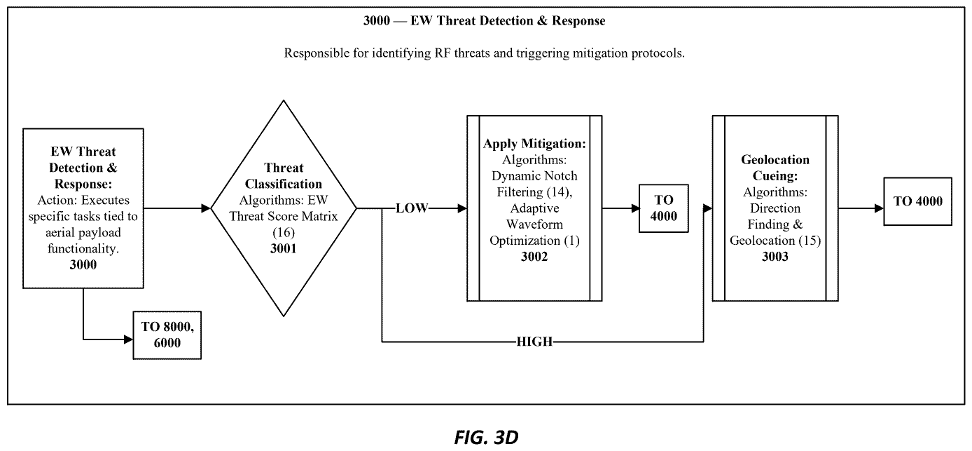

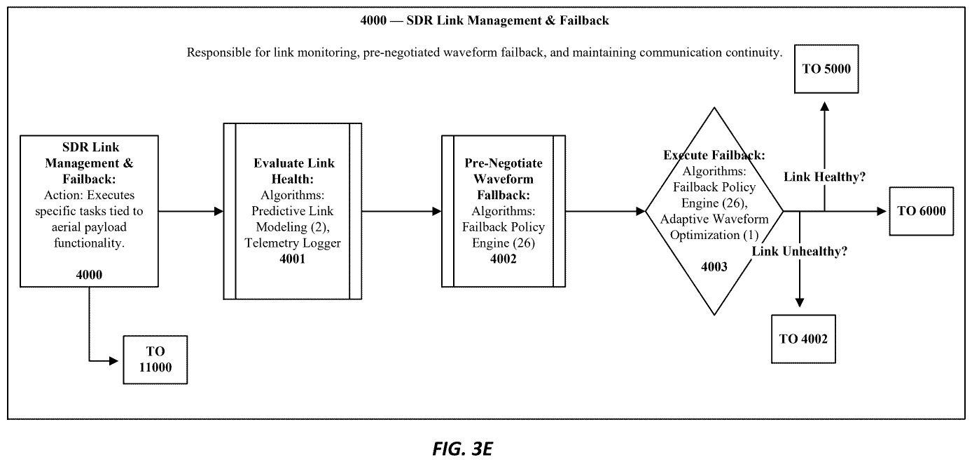

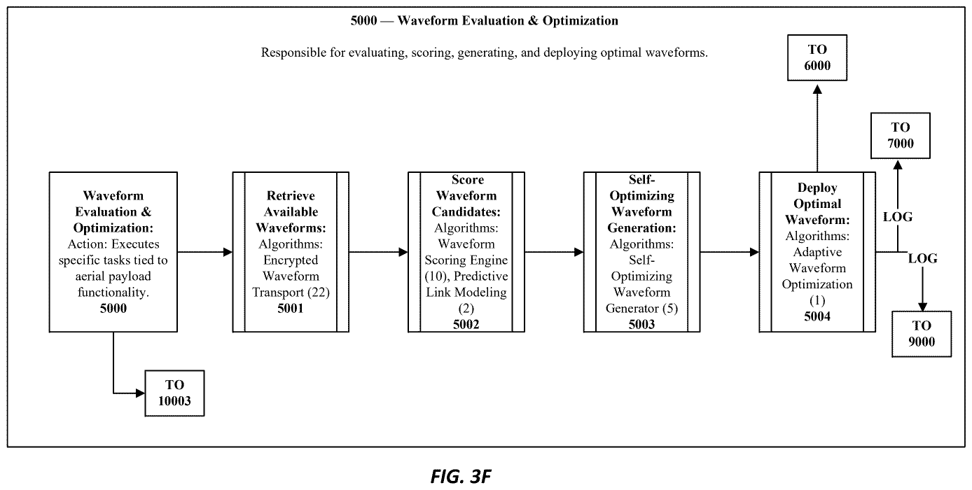

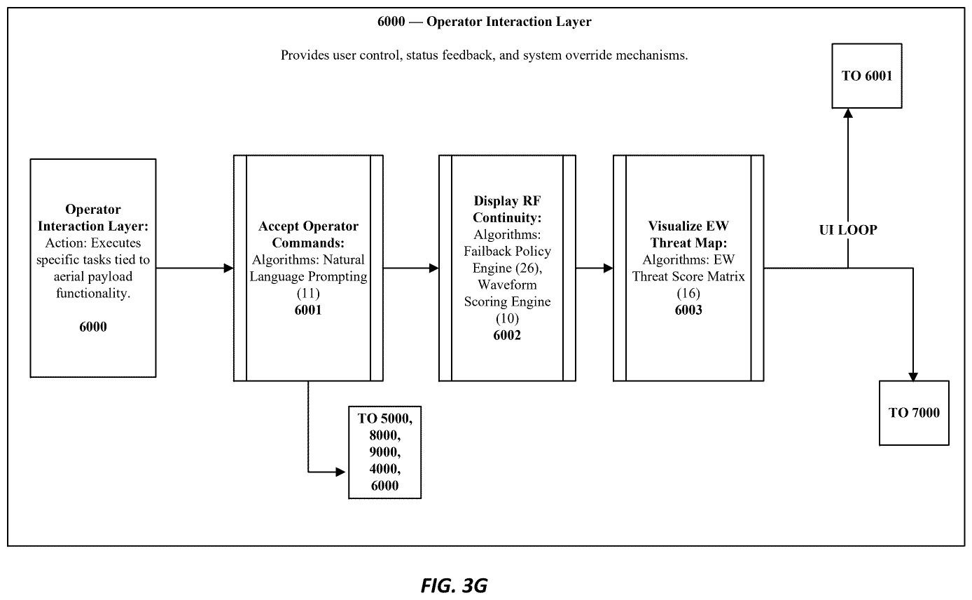

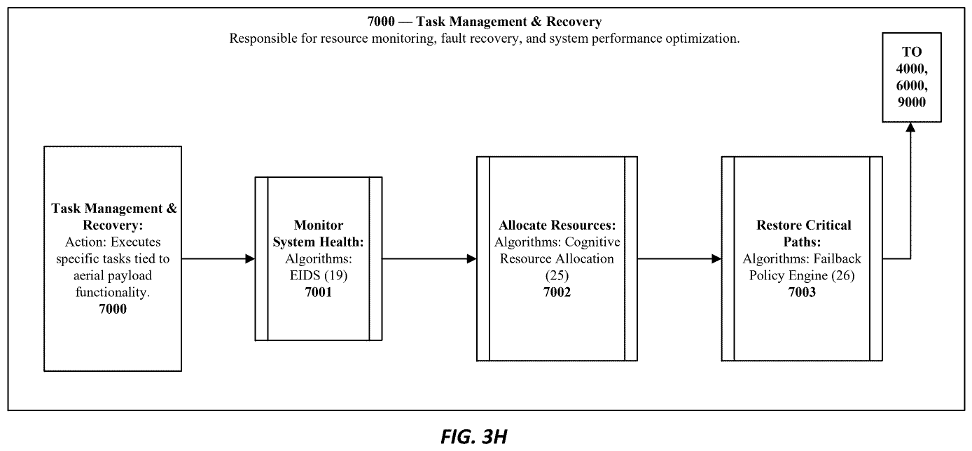

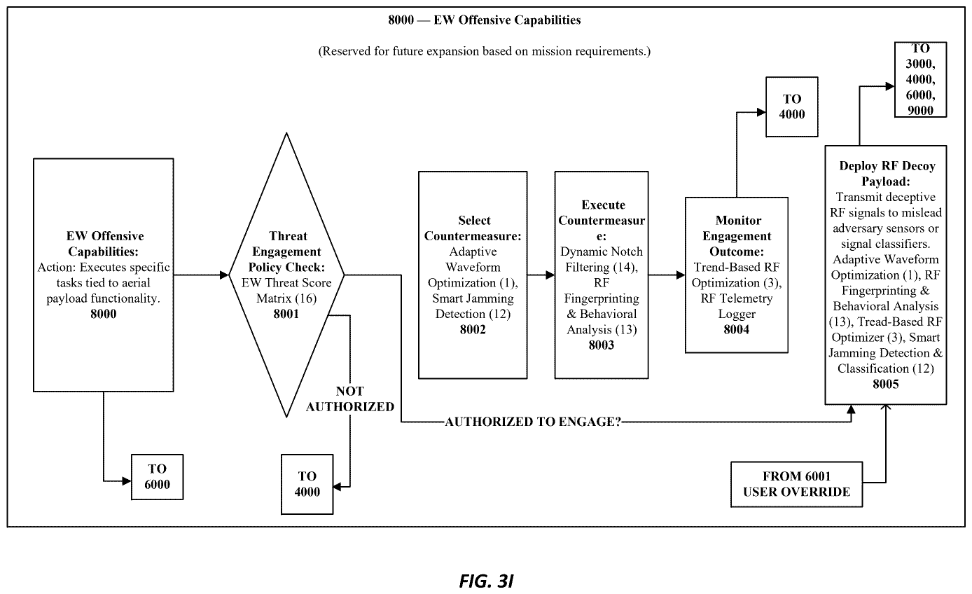

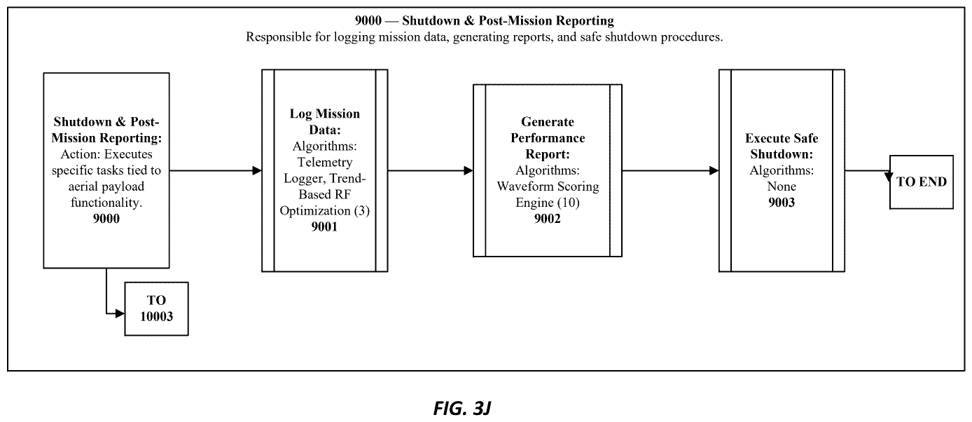

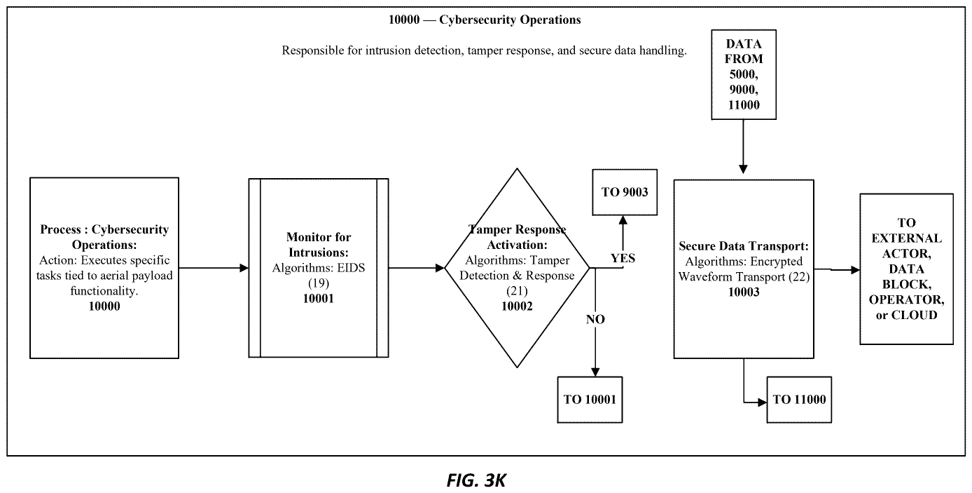

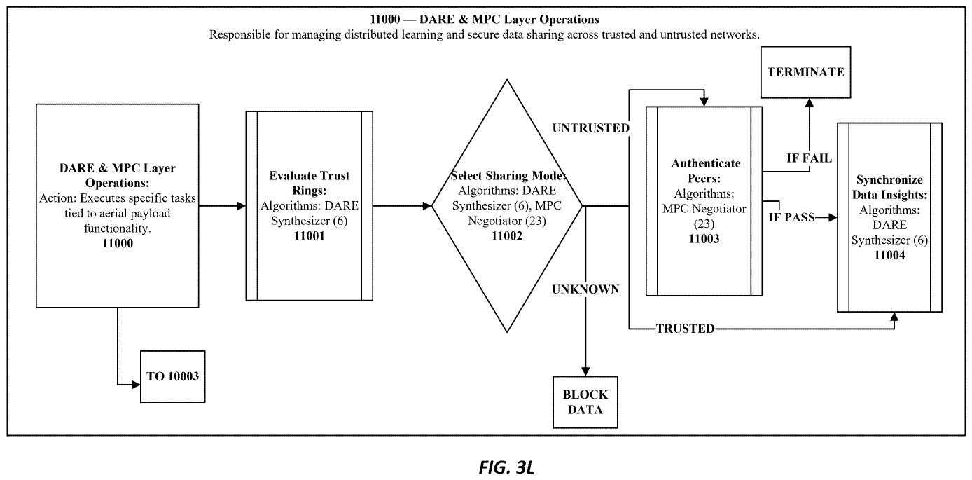

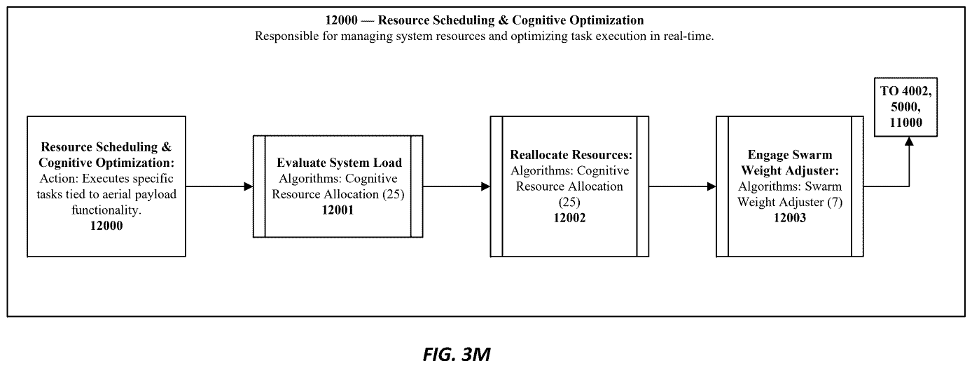

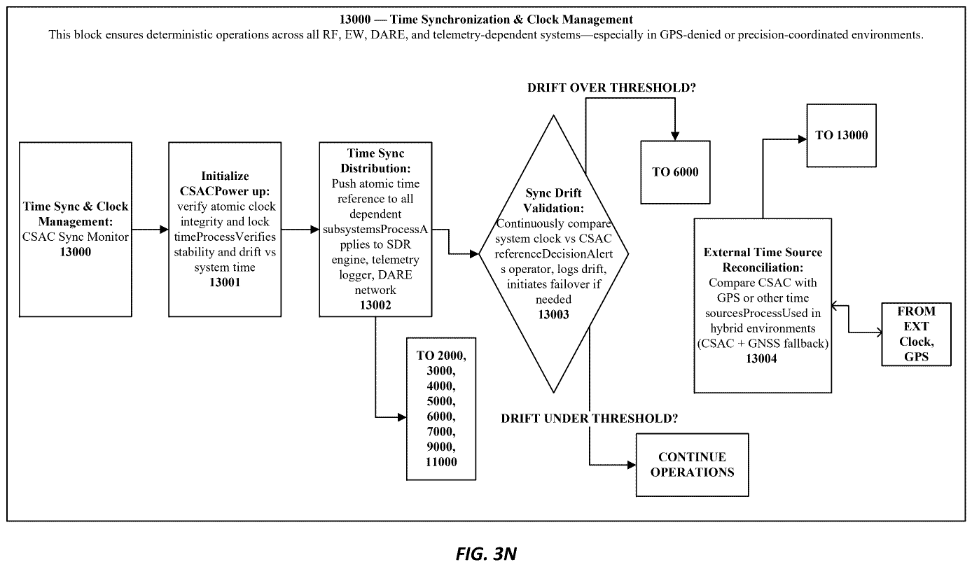

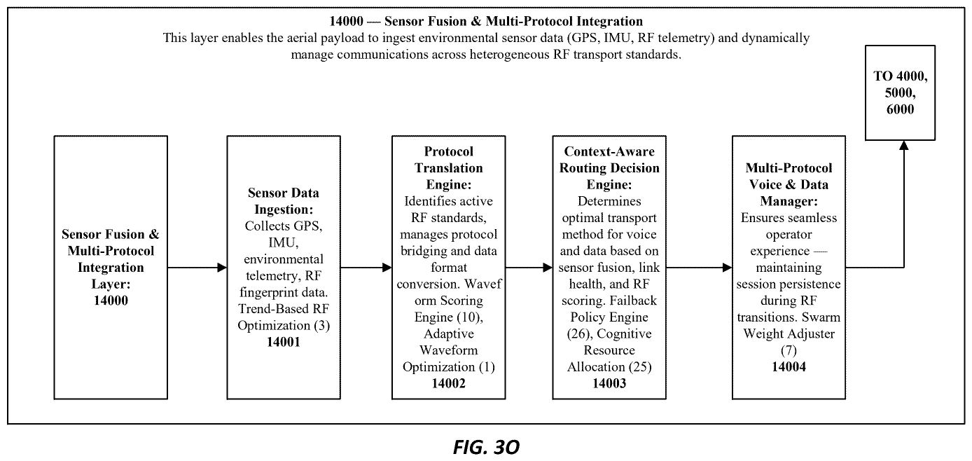

FIG. 3A illustrates example system data blocks, which may serve as centralized data structures that enable real-time coordination and context sharing across functional modules within the gateway. These blocks may contain mission parameters, trust scores, waveform performance logs, link health metrics, telemetry snapshots, and access control states, all structured for fast retrieval and update. Modules such as the Cognitive Engine, EW Threat Score Matrix, Failback Policy Engine, and Adaptive Waveform Optimizer read from and write to the System Data blocks to maintain situational awareness and synchronize their actions. For example, when the Spectrum Analysis module detects a rise in interference, it can log the anomaly to the System Data block, which is then immediately referenced by the waveform scoring engine and failback trigger logic. This architecture allows algorithms operating in parallel to remain aligned with system state, making the gateway resilient, context-aware, and capable of autonomous response without relying on external command.

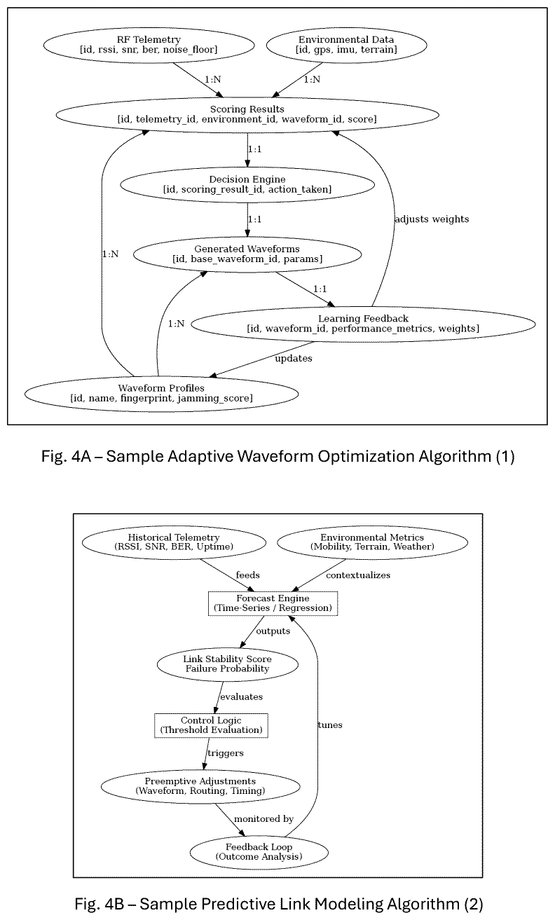

A first algorithm enables the gateway to perform adaptive waveform optimization. This algorithm can select and apply one or more optimal waveform configurations based on real-time RF telemetry, environmental conditions, and system policy. It can ensure resilient communications by dynamically adjusting SDR parameters in response to interference, jamming, or link degradation. It is a component of the Cognitive Engine subsystem and can be visualized in FIGS. 3D, 3E, 3F, 3I and 3O in Process Blocks: 3000, 4000, 5000, 8000, and 14000. One example of logic flow for this algorithm is shown in FIG. 4A. The algorithm can enable the gateway to select one or more optimal waveforms using real-time RF metrics and can achieve the goal of maintaining the quality of communication under variable RF conditions. The Adaptive Waveform Optimization algorithm can integrate real-time RF telemetry (e.g., RSSI, SNR, BER, Doppler shift) with predictive modeling and operational context to dynamically configure SDR parameters. It can use an internal API framework to interface with SDR hardware and telemetry sources, allowing the system to ingest data and apply waveform adjustments in sub-second intervals. A Model Context Protocol (MCP) can inject mission-specific directives, environmental constraints (e.g., terrain, mobility, bandwidth), and priority profiles into the decision engine, ensuring waveform selection aligns with current operational demands. Additionally, Multi-Party Computation (MPC) can be employed to securely aggregate telemetry from distributed nodes, enabling collaborative waveform scoring without exposing raw node data. This combination of telemetry fusion, contextual awareness, secure distributed input, and API-driven control allows the system to maintain resilient, mission-aligned communications in contested or DDIL environments.

A second algorithm enables the gateway to perform predictive link modelling. This algorithm can forecast communication link performance by analyzing historical telemetry data and current environmental metrics. It can enable the gateway to preemptively adjust communication settings before a link failure or degradation occurs, maintaining operational continuity. It is a component of the Cognitive Engine subsystem and can be visualized in FIGS. 3E and 3F, in Process Blocks: 4000 and 5000. One example of logic flow for this algorithm is shown in FIG. 4B. It can enable the gateway to anticipate link degradation based on telemetry trends and enable proactive waveform or routing changes. The Predictive Link Modeling algorithm can process historical RF telemetry including signal strength, link uptime, SNR, and BER alongside current environmental inputs such as platform velocity, terrain topology, and known interference patterns. It can apply time-series forecasting and regression techniques to generate a rolling link stability score and failure probability index, which can be continuously or near-continuously updated in real time. When thresholds are met, the algorithm can trigger preemptive adjustments to waveform parameters, routing paths, or transmission timing via internal APIs, ensuring communication continuity before degradation becomes observable.

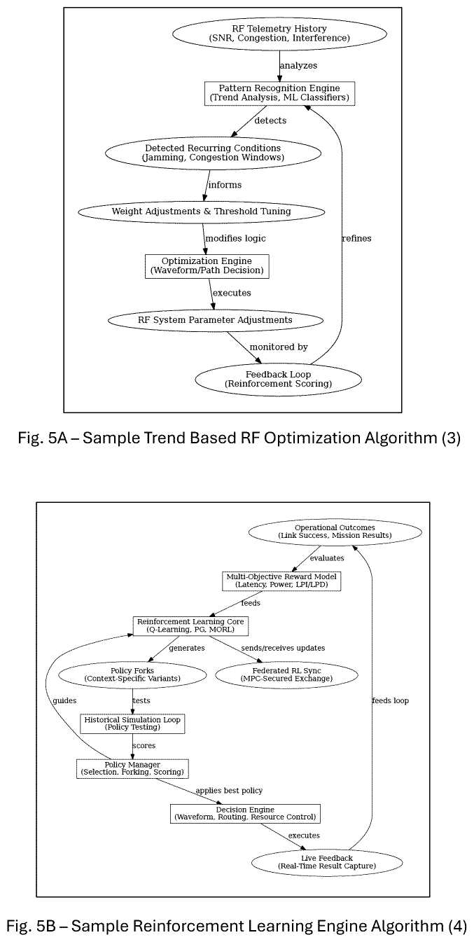

A third algorithm enables the gateway to perform trend-based RF optimization. This algorithm can monitor environmental metrics and telemetry over time to identify patterns in RF behavior. It can adjust system parameters and optimization weights based on observed trends to improve long-term performance and efficiency in dynamic RF environments. It is a component of the Optimization Engine subsystem and can be visualized in FIGS. 3C, 3F, 3I, 3J and 3O, in Process Blocks: 2000, 5000, 8000, 9000, and 14000. One example of logic flow for this algorithm is shown in FIG. 5A. It can enable the gateway to analyze RF history to inform future configuration decisions and can achieve the goal of improving overall gateway stability and reduce overly reactive switching. The Trend-Based RF Optimization algorithm can continuously or near-continuously aggregate RF telemetry and environmental data over time to identify recurring patterns such as interference cycles, congestion windows, or link degradation trends. It can use temporal analysis techniques such as weighted moving averages, signal classification models, or trend scoring functions to dynamically adjust waveform selection weights, switching thresholds, and optimization bias. By learning from historical behavior, the algorithm can reduce unnecessary configuration changes and ensures stable, efficient performance in evolving RF environments.

A fourth algorithm enables the gateway's reinforcement learning engine. This algorithm can use operational outcomes and feedback to improve system decision-making over time. It can refine policies for waveform selection, routing, and resource management based on reward signals from mission performance and link success rates. It is a component of the Decision Engine subsystem and can be visualized in FIG. 3 in Process Block 5000. One example of logic flow for this algorithm is shown in FIG. 5B. It can enable the gateway to learn and improve performance toward optimal RF behavior using feedback loops and can achieve the goal of enhancing performance through self-improvement. The Reinforcement Learning Engine can leverage multi-objective reward signals derived from mission outcomes, link performance, and environmental constraints to refine decision policies in real time. It can support federated reinforcement across distributed nodes using MPC-secured learning feedback and can fork policy branches based on mission role or operational context. Before deployment, the engine can validate new policies against historical RF telemetry in a simulated test loop, enabling safe, context-aware optimization of waveform selection, routing, and resource allocation.

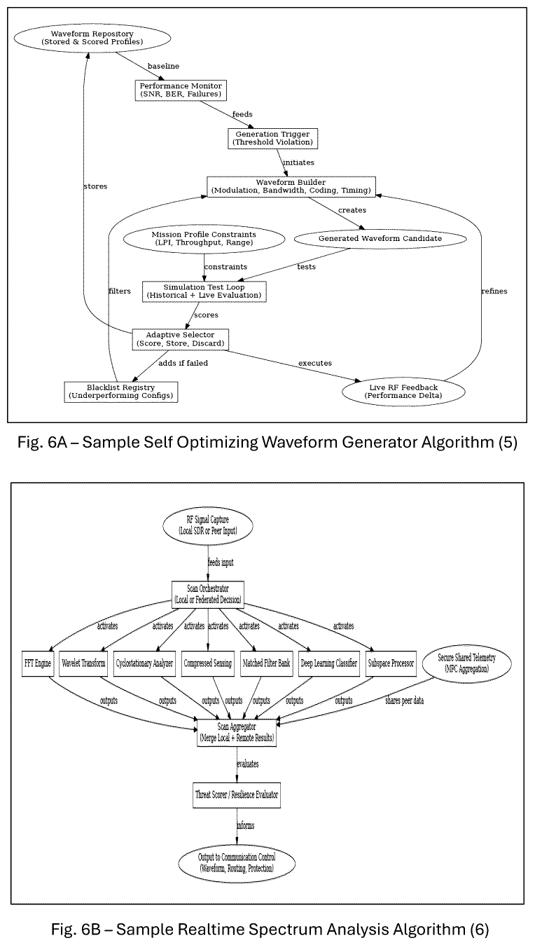

A fifth algorithm enables the gateway to employ a self-optimizing waveform generator. This algorithm can generate new waveform candidates within defined system parameters when existing waveforms fail to meet performance requirements. It can enable real time waveform creation tailored to specific RF environments or mission constraints. It is a component of the Waveform Synthesis subsystem and can be visualized in FIG. 3F, in Process Block 5000. One example of logic flow for this algorithm is shown in FIG. 6A. It can generate new waveform variants based on success criteria and can enhance the gateway's overall adaptability to novel RF environments. The gateway can monitor waveform performance in real-time and trigger a self-optimization loop when signal quality or mission constraints are violated. A waveform builder engine dynamically assembles new candidates from a modular library of modulation schemes, bandwidths, coding rates, and timing parameters, guided by mission profiles, environmental telemetry, and optionally synchronized with an external waveform repository on the network. Each candidate can be evaluated against historical success data and live performance metrics, with underperforming variants added to a blacklist to prevent future reuse enabling the gateway to iteratively refine waveform generation and selection based on both local outcomes and shared network intelligence.

A sixth algorithm can enable the gateway to perform real-time spectrum analysis. The algorithm can regularly, episodically, or continuously scan and process RF spectrum data to classify signals, detect interference, and build a real-time RF environment map. It can provide critical input to other algorithms for environmental awareness and threat detection. It is a component of the RFF Sensor subsystem and can be visualized in FIG. 3C, in Process Block 2000. One example of logic flow for this algorithm is shown in FIG. 6B. It can monitor spectrum for energy, interference, occupancy and can achieve the goal of improving informed band/channel selection. The gateway can use a modular scan orchestrator to dynamically activate and coordinate multiple spectral analysis techniques FFT, wavelet transform, cyclostationary detection, compressed sensing, matched filtering, deep learning classification, and subspace methods based on real-time RF conditions and mission constraints. These scan modes can operate locally on a single SDR platform or be distributed across multiple nodes that share telemetry and scan results via secure peer-to-peer protocols. The aggregated scan intelligence can enable adaptive waveform selection, routing, and link protection strategies to maintain communication resilience in contested or degraded spectrum environments.

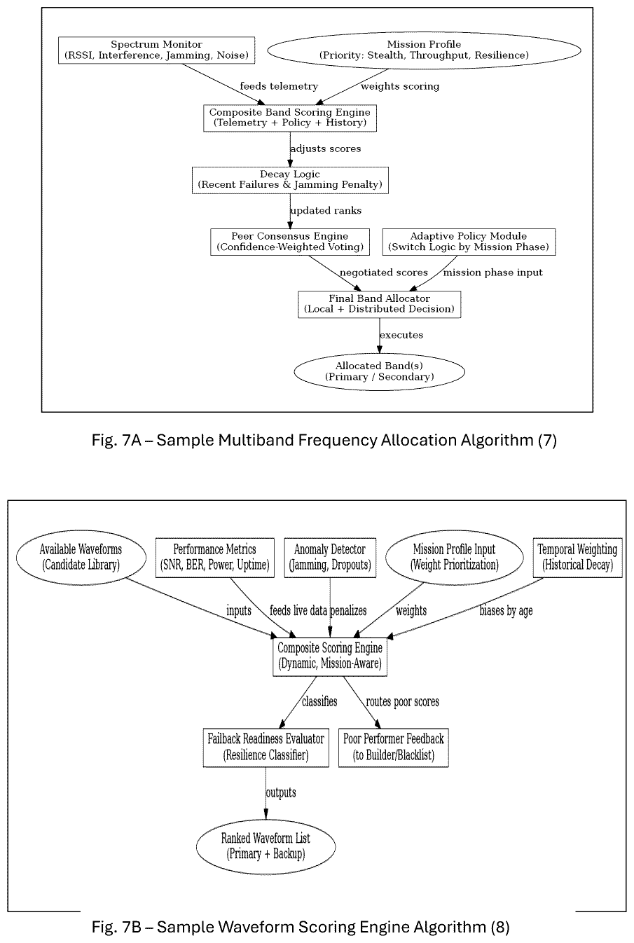

A seventh algorithm can enable the gateway to improve its multi-band frequency allocation. The algorithm can enable the gateway to allocate and manage communication resources across multiple frequency bands, selecting suitable or most suitable bands for transmission, based on RF conditions, operational policy, and environmental interference. It is a component of the RF Spectrum Manager subsystem and can be visualized in FIG. 3F, in Process Block 5000. One example of logic flow for this algorithm is shown in FIG. 7A. It can allocate one or more RF bands dynamically based on mission profile and spectrum condition and can achieve the goal of avoiding congestion and jamming zones. The gateway can continuously or near-continuously monitor real-time RF conditions across multiple frequency bands, evaluating interference, jamming, link health, and historical performance using a composite scoring model guided by mission-specific policies. Bands are ranked based on telemetry, policy weightings (e.g., stealth, throughput), and prior success, while degraded or compromised bands are temporarily penalized using a decay mechanism to avoid reuse. Nodes may negotiate preferred bands via a secure peer-to-peer protocol, using a confidence-weighted consensus mechanism that enables adaptive policy switching and distributed coordination of frequency allocation in dynamic or contested environments.

An eight algorithm can enable the gateway to score or rank waveforms. This algorithm can evaluate available waveforms against system-defined metrics such as link quality, resiliency, and performance history. It can generate a ranked list or array of waveform candidates for use in optimization or failback scenarios. It is a component of the Decision Engine subsystem and can be visualized in FIGS. 3F, 3G, 3J and 3O in Process Blocks 5000, 6000, 9000, and 14000. One example of logic flow for this algorithm is shown in FIG. 7B. It can enable the gateway to quantify waveform performance using composite metrics and achieve the goal of making more intelligent waveform selections. The gateway can evaluate all available waveform candidates using a dynamic composite scoring engine that considers link quality, power efficiency, resiliency under interference, and historical success across mission contexts. Scoring weights are adjusted in real-time based on operational goals, environmental conditions, and anomaly detection triggers such as jamming or dropouts, with older performance data decaying over time to emphasize recency. Waveforms are ranked and classified by resilience class for failback readiness, and those with repeated underperformance are flagged and routed to the self-optimizing waveform engine for future exclusion or regeneration.

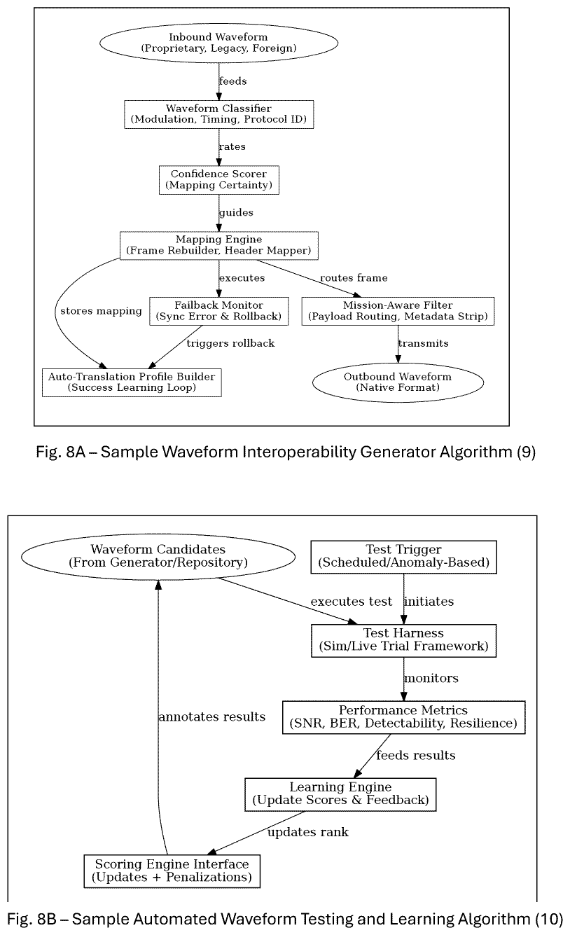

A ninth algorithm can enable the gateway to employ a waveform interoperability translator. This algorithm can translate between different waveform types or protocol structures to ensure communication between incompatible radios or SDR platforms. It can enable cross-domain interoperability within multi-vendor or multi-nation networks. It is a component of the Cross-Waveform Adapter subsystem and can be visualized in FIG. 3I, in Process Block 8000. One example of logic flow for this algorithm is shown in FIG. 8A. It can enable translation between incompatible waveform protocols and achieve the goal of enabling more seamless radio interoperability across dissimilar platforms. The gateway can enable real-time translation between dissimilar waveform protocols, modulation types, framing structures, and timing formats to support seamless communication across incompatible radios and SDR platforms. A classification engine can detect waveform characteristics and applies rule-based or machine-learned mapping profiles, with support for confidence scoring, auto-generated translation templates, and mission-aware filtering that adapts headers and payloads to security and operational constraints. The translator can include bidirectional conversion, failback sync detection, and metadata sanitization for coalition, cross-domain, and contested RF environments.

A tenth algorithm can enable automated waveform testing and learning. This algorithm can test waveform candidates in real or simulated environments, learn from performance outcomes, and update scoring metrics. It can accelerate validation and ensure that the waveform library remains current and potentially optimized for then-current conditions. It is a component of the Learning Engine subsystem and can be visualized in FIG. 3F, in Process Block 5000. One example of logic flow for this algorithm is shown in FIG. 8B. It can enable the gateway to test waveforms under live or simulated conditions and enhance overall gateway performance, achieving the goal of refining waveform scoring and selection over time. The gateway can execute waveform trials in simulated or live RF environments using a test harness that measures performance across metrics such as SNR, BER, resilience, and detectability. Results can be fed into a learning engine that updates the internal scoring model, reinforcing successful configurations and flagging underperformers for exclusion or further tuning. Testing can be triggered on a schedule or in response to anomalies, ensuring the waveform library evolves based on real-world telemetry and mission feedback.

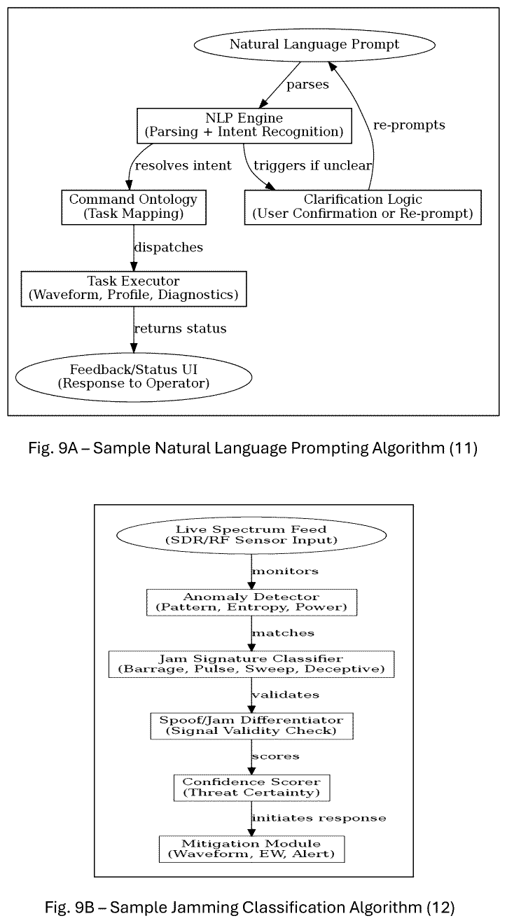

An eleventh algorithm can enable natural language prompting to enhance user involvement. This algorithm can interpret operator commands using natural language processing and convert them into actionable system tasks. It can allow non-technical operators to interface with the system efficiently without needing in-depth RF knowledge. It is a component of the Operator Interface subsystem and can be visualized in FIG. 3G, in Process Block 6000. One example of logic flow for this algorithm is shown in FIG. 9A. It can allow the gateway to parse human input for control and feedback commands and achieves the goal of enhancing usability and operator trust. The gateway can allow operators to interact using natural language commands, which are parsed by an NLP engine and resolved against a structured command ontology. Prompts are converted into executable tasks such as waveform selection, diagnostics, or profile changes with clarification logic used to confirm or refine unclear inputs. This can enable non-technical personnel to configure and operate the system efficiently while maintaining transparency and feedback through adaptive prompting.

A twelfth algorithm can enable the gateway to better detect and classify RF jamming. This algorithm can detect and classify jamming or spoofing attempts within an RF environment. It can enable rapid threat identification and inform countermeasure selection within the EW mitigation framework. It is a component of the EW Sensor Engine subsystem and can be visualized in FIGS. 3C, 3D and 3I, in Process Blocks 2000, 3000, and 8000. One example of logic flow for this algorithm is shown in FIG. 9B. It can enable the gateway to detect and classify jamming attempts based on RF behavior patterns and achieve the goal of enabling faster mitigation and threat adaptation. The gateway can continuously or near-continuously monitor spectrum activity for anomalies in power, structure, or entropy that indicate potential jamming or spoofing. Detected threats can be classified against known jamming signatures such as barrage, sweep, pulse, or deceptive and scored for confidence, while spoofing is differentiated using signal validation logic. The classification result can inform downstream mitigation actions, including waveform adaptation, countermeasure activation, or alert generation.

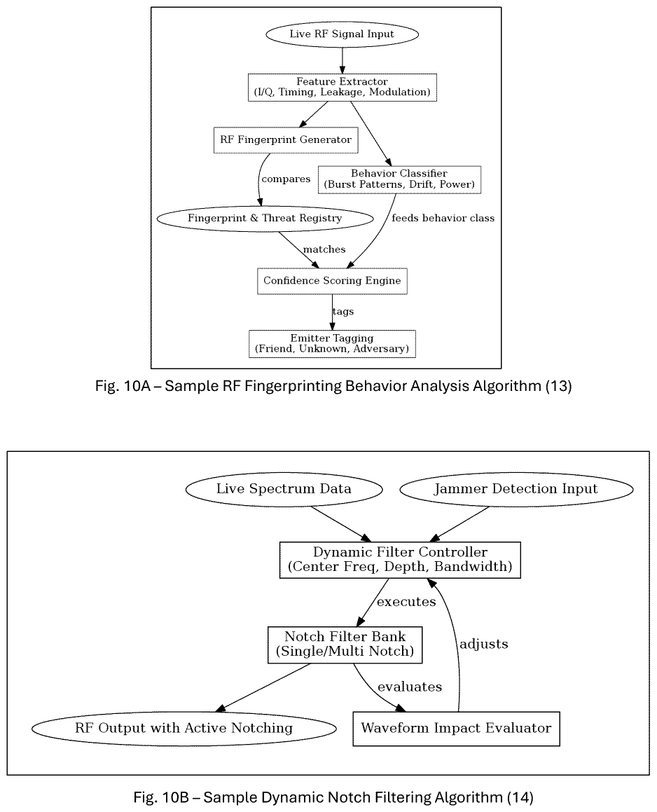

A thirteenth algorithm enables RF fingerprinting and behavior analysis. This algorithm can analyze signal characteristics and transmission behaviors to identify and classify RF emitters. It supports the gateway's ability to differentiate between friendly, neutral, and adversarial signals. It is a component of the Threat Intelligence Core subsystem and can be visualized in FIGS. 3C, 3D and 3I, in Process Blocks 2000, 3000, and 8000. One example of logic flow for this algorithm is shown in FIG. 10A. It can enable the gateway to identify emitters via unique RF characteristics and achieve the goal of differentiating among friend, foe, and unknown emitters. The system can capture RF signals and extract low-level features such as I/Q imbalance, frequency stability, burst timing, and spectral leakage to generate unique emitter fingerprints. These fingerprints can be compared against a known emitter database while behavioral traits (e.g., duty cycle, drift, modulation idiosyncrasies) are used to further classify signals as friendly, unknown, or adversarial. A confidence scoring engine can refine classification in real time, allowing the gateway to make dynamic friend-foe-unknown determinations even in dense or contested environments.

A fourteenth algorithm enables the gateway to perform dynamic notch filtering. This algorithm can apply targeted notch filters to suppress unwanted signals or jamming without unduly degrading system communications. It can dynamically adjust filter parameters based on real-time spectrum analysis and threat detection. It is a component of the RF Defensive Layer subsystem and can be visualized in FIGS. 3D and 3I, in Process Blocks 3000 and 8000. One example of logic flow for this algorithm is shown in FIG. 10B. It can enable to the gateway to apply real-time suppression to targeted jamming signals and achieve the goal of preserving link health under narrowband interference. The gateway can analyze spectrum activity and identify jamming threats to apply real-time digital notch filters that suppress unwanted signals with minimal impact on critical communications. A dynamic filter controller can adjust center frequency, depth, and bandwidth parameters in response to changing jammer behavior and feedback from waveform performance metrics. The filter engine can support simultaneous notch deployments and waveform-aware adjustment logic to ensure communications resilience under narrowband or coordinated interference.

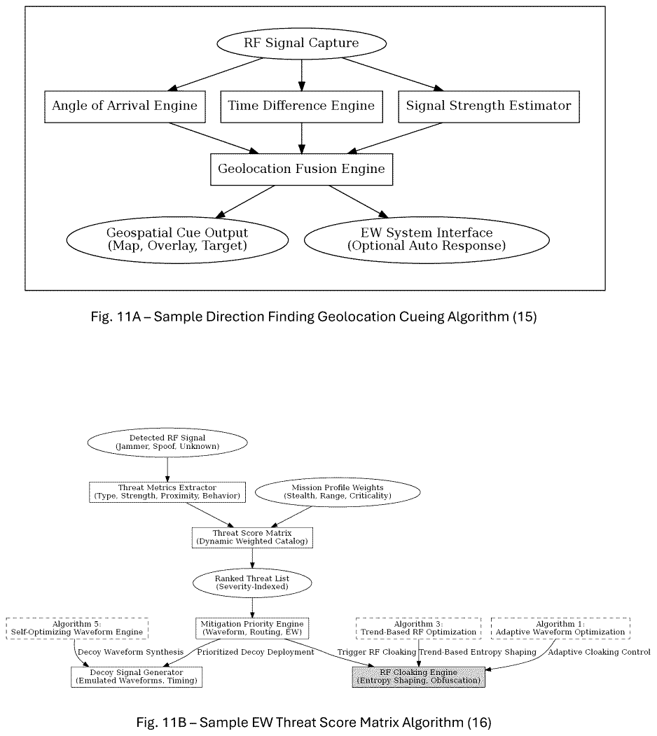

A fifteenth algorithm enables the gateway to improve direction finding and geolocation cueing. This algorithm can estimate the location of one or more RF emitters using directional signal analysis and geolocation techniques. It can provide geospatial cueing data for operators or automated EW responses. It is a component of the Targeting Module subsystem and can be visualized in FIG. 3D, in Process Blocks 3000. One example of logic flow for this algorithm is shown in FIG. 11A. It can enable the gateway's ability to estimate direction/location of RF sources and enhance overall system geo location cueing and threat awareness. The system estimates the direction and location of RF emitters using a combination of angle-of-arrival (AoA), time-difference-of-arrival (TDOA), and received signal strength indicators (RSSI). These data streams can be fused through a geolocation engine that provides cueing overlays for situational awareness, targeting, or electronic warfare tasking. The algorithm can operate across onboard or networked sensor nodes, enabling low-latency emitter localization even in GPS-denied or cluttered RF environments.

A sixteenth algorithm enables the gateway to employ an EW threat score matrix or catalog. This algorithm can calculate a threat score for detected RF signals based on multiple factors including jamming type, signal strength, proximity, and behavior. It can rank threats by severity and inform mitigation strategies. It is a component of the EW Response Engine and can be visualized in FIG. 3D, in Process Block 3000. One example of logic flow for this algorithm is shown in FIG. 11B. It can enable threat ranking based on severity, proximity, and type, and potentially other parameters, and enhance the gateway's ability to prioritize response and waveform strategies. The system can calculate a threat score for each detected RF emitter by evaluating parameters such as jamming type, power level, proximity, behavioral profile, and duration. These parameters can be weighted dynamically using a mission-specific scoring matrix that prioritizes threats based on tactical relevance, criticality, and historical context. The resulting ranked list can be used to trigger mitigation actions, adapt waveform and routing strategies, and focus defensive measures on the highest-severity signals.

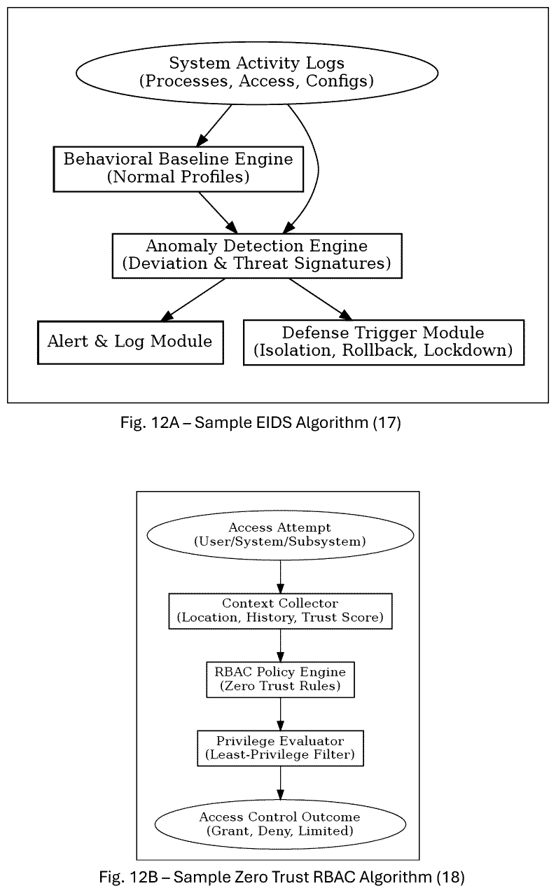

A seventeenth algorithm enables the gateway to employ an embedded intrusion detection system (EIDS). This algorithm can fully or nearly continuously monitor system activity to detect unauthorized access attempts, anomalies, or malicious behavior. It can enable real-time or nearly real-time cybersecurity defense by flagging potential breaches and triggering protective measures. It is a component of the Cybersecurity Layer subsystem and can be visualized in FIGS. 3B, 3H and 3K, in Process Block 1000, 7000, and 10000. One example of logic flow for this algorithm is shown in FIG. 12A. It can detect anomalous access or compromise attempts and can trigger alerts or self-protection protocols. The system continuously monitors internal activity including user sessions, process execution, file access, and configuration changes against a real-time behavioral baseline. An anomaly detection engine can identify deviations or known threat signatures such as privilege escalation, remote shell attempts, or unauthorized service changes. Detected events can trigger alerts and can activate self-defense protocols such as subsystem isolation, rollback, or full lockdown depending on severity.

An eighteenth algorithm enables the gateway to employ zero trust role-based access. This algorithm can enforce access control policies based on user roles, trust levels, contextual factors, and other indicative parameters. It can ensure that each system component or user can only access the resources necessary for the user's function, minimizing lateral movement and unauthorized commands. It is a component of the Access Control Layer subsystem and can be visualized in FIGS. 3B, 3H and 3K, in Process Blocks: 1000, 7000, and 10000. One example of logic flow for this algorithm is shown in FIG. 12B. It can restrict feature access by user role, trust profile, or other parameters and prevent lateral movement and configuration tampering. The gateway can enforce access policies using a zero-trust model that evaluates every access request against contextual information such as role, trust score, location, session behavior, and command history. Each request can be filtered through a least-privilege policy engine that dynamically determines allowable actions based on risk and operational requirements. This can ensure that users, subsystems, and services only access the minimum set of resources necessary, preventing lateral movement, privilege abuse, or system misconfiguration.

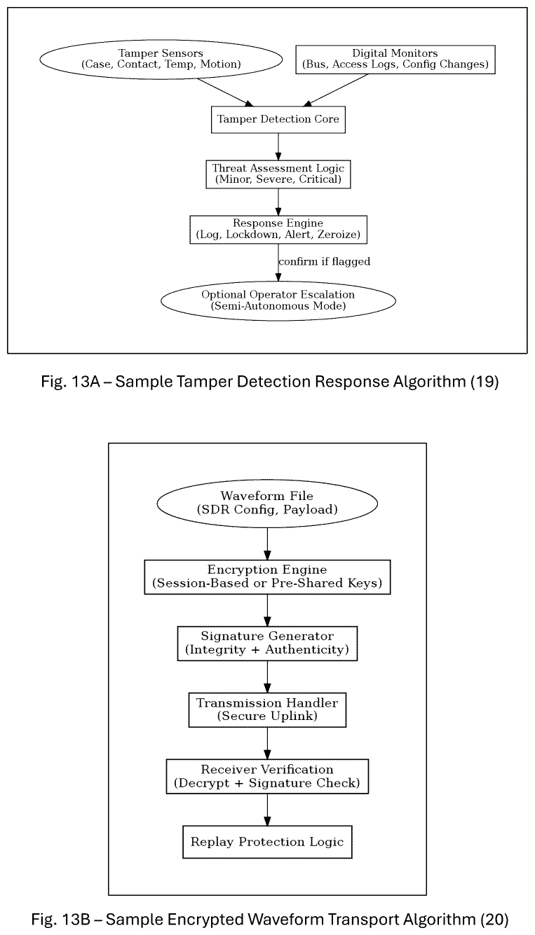

A nineteenth algorithm enables the gateway to detect and respond to tampering. This algorithm can detect physical or digital tampering attempts and initiate one or more responses, such as logging, lockdown, or wiping data. It can provide an autonomous or semi-autonomous layer of protection, including for sensitive or high-risk deployment environments. It is a component of the Physical Security Layer subsystem and can be visualized in FIGS. 3B, 3H and 3K, in Process Blocks 1000, 7000, and 10000. One example of logic flow for this algorithm is shown in FIG. 13A. It can detect physical tampering or breach and initiate protective procedures, such as lockdown or zeroize procedures, meaning implementing a process of erasing or deleting data or overwriting with zeros. The gateway can monitor physical sensors (such as contact, temperature, and motion) and digital activity (including bus access and configuration changes) to detect tampering attempts. A threat level can be assigned based on severity and type, triggering a response protocol that may include logging, locking down interfaces, alerting operators, or initiating secure data wipe (zeroization). The response path can be policy-driven and can operate autonomously or prompt operator confirmation depending on mission configuration.

A twentieth algorithm enables the gateway to employ encrypted waveform transport. This algorithm can securely encrypt waveform files and SDR configuration data for transmission across the network. It can ensure waveform integrity and confidentiality during storage and deployment, especially across untrusted links. It is a component of the Waveform Security Engine subsystem and can be visualized in FIGS. 3F and 3K, in Process Blocks: 5000 and 10000. One example of logic flow for this algorithm is shown in FIG. 13B. It can secure waveform payloads via encryption and signature validation and enhance the gateway's ability to prevent waveform injection and replay attacks. The gateway can encrypt waveform files and SDR configuration payloads using session-based or pre-distributed encryption keys, then sign the package for integrity verification. Upon receipt, the destination node can verify the signature, decrypt the payload, and check for replay using timestamp and nonce validation. This can ensure secure and authenticated waveform transport, preventing injection, tampering, or unauthorized reuse across untrusted networks.

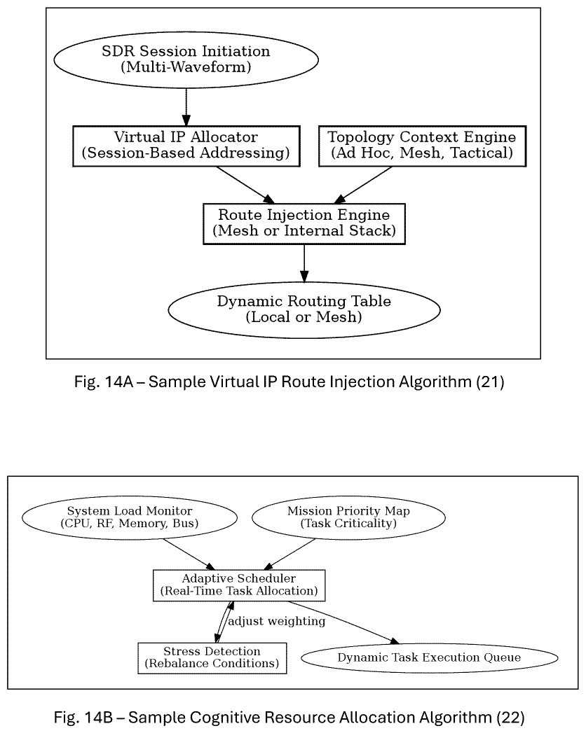

A twenty-first algorithm enables the gateway to perform virtual IP assignment and route injection. This algorithm can dynamically assign virtual IP addresses and inject routing paths into the system's internal network or an ad hoc or mesh network being used. It can enable seamless communication between devices regardless of underlying protocol or topology. It is a component of the Network Stack subsystem and can be visualized in FIG. 3L, in Process Block 11000. One example of logic flow for this algorithm is shown in FIG. 14A. It can assign virtual IP addresses to SDR sessions and inject routes, enabling abstracted, seamless multi-waveform networking. The gateway can assign virtual IP addresses to SDR sessions, decoupling logical addressing from the underlying RF or waveform link layer. It can dynamically inject route entries into the local or mesh routing stack, guided by real-time topology awareness and mission-defined policies. This can enable seamless, protocol-agnostic communication across disparate radios, waveforms, and transport layers without manual network reconfiguration.

A twenty-second algorithm can enable the gateway to employ cognitive resource allocation. This algorithm can evaluate task priority, system load, and resource availability to dynamically schedule processes and distribute compute effort. It can ensure mission-critical tasks are prioritized under constrained conditions. It is a component of the System Scheduler subsystem and can be visualized in Process Block 12000. One example of logic flow for this algorithm is shown in FIG. 14B. It can assign and redistribute compute/memory/RF priorities based on mission state and enhance and maintain system efficiency under stresses. The gateway can evaluate real-time system load (CPU, RF, memory), mission task priority, and resource availability to dynamically schedule and allocate processing effort. A scheduler engine can assign or reassign resources based on current stress conditions and mission phase to ensure critical functions like waveform switching, jamming response, or telemetry handling are prioritized. A rebalance logic can monitor for performance degradation and adjusts task weighting and queue placement accordingly to sustain efficiency under constrained or high-demand conditions.

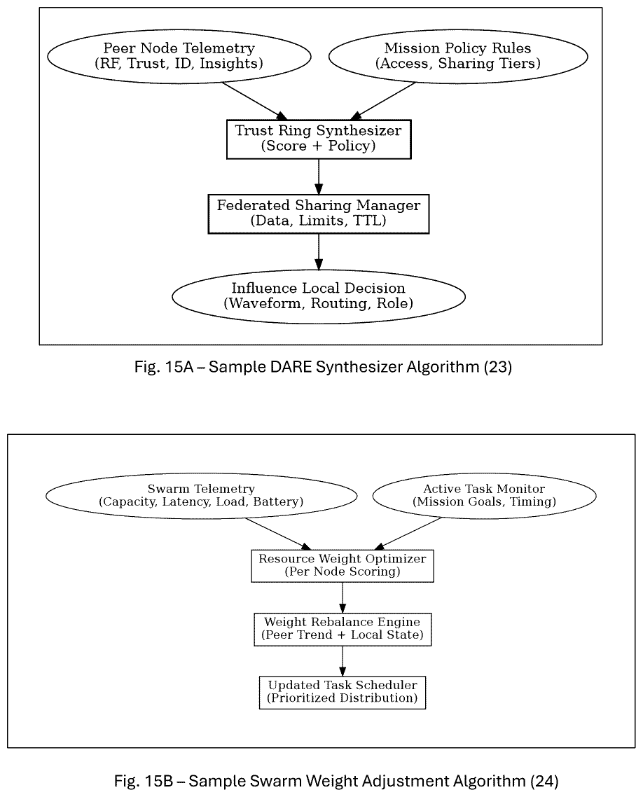

A twenty-third algorithm can enable a distributed adaptive radio engine (DARE) synthesizer. This algorithm can manage trust relationships and data-sharing configurations across distributed nodes. It can establish and adjust trust rings dynamically based on mission policy, node identity, and peer telemetry exchange. It is a component of the Fleet Intelligence Mesh (DARE Layer) subsystem and can be visualized in FIG. 3, in Process Blocks 1000 and 11000. One example of logic flow for this algorithm is shown in FIG. 15A. It can aggregate RF telemetry/insights from other nodes and improve the gateway's ability to make local decisions using distributed learning and other techniques described herein. The gateway can aggregate RF telemetry, trust scores, and peer node identity to dynamically generate trust rings and sharing permissions based on mission rules. Using this synthesized trust model, a federated sharing manager can control which insights are shared, with whom, and for how long (TTL), optimizing cross-node intelligence without centralized control. These insights can then be used to inform local decisions such as waveform selection, routing strategy, or node behavior within the mesh.

A twenty-fourth algorithm can enable the gateway to adjust swarm weights among available UAV and other resources. This algorithm can monitor system load, resource availability, and task priority across multiple nodes. It can adjust resource allocation weights and task scheduling to optimize distributed system performance and balance workloads. It is a component of the Cognitive Resource Manager subsystem and can be visualized in FIG. 3, in Process Block 12000. One example of logic flow for this algorithm is shown in FIG. 15B. It can adjust local priority weights based on peer performance trends and align system behavior with fleet-level optimization. The gateway can monitor UAV or node telemetry such as performance capacity, latency, load, and energy level alongside active task requirements to update scheduling weights. A resource optimizer can evaluate local and peer states to rebalance workload distribution across the swarm, ensuring degraded or constrained nodes offload responsibilities. Task allocation can then be dynamically updated to reflect this balance, aligning system performance with mission goals while maintaining resiliency and responsiveness.

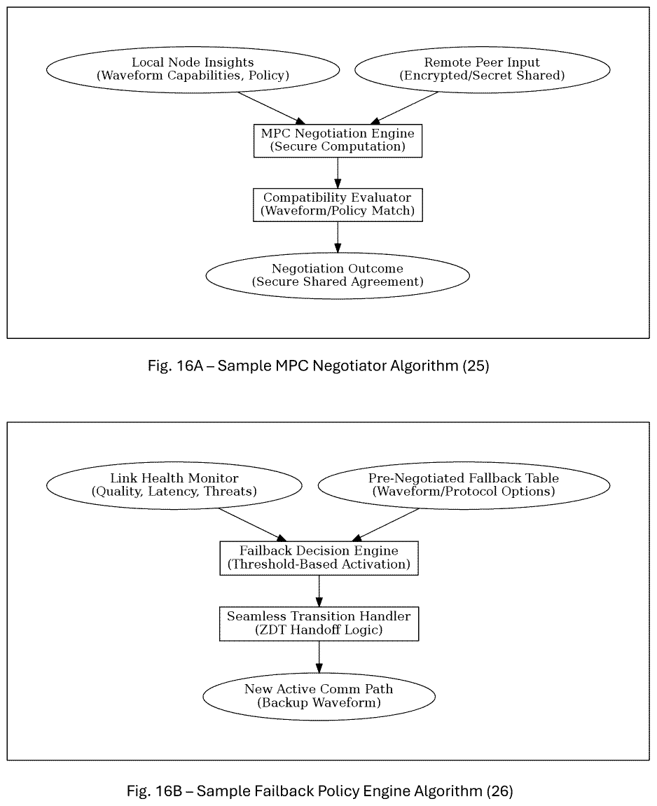

A twenty-fifth algorithm can enable a multi-party computation (MPC) negotiator. This algorithm can employ MPC techniques to securely negotiate shared data exchange between untrusted or semi-trusted nodes. It can allow the system to synchronize insights without revealing sensitive raw data. It is a component of the Cybersecure Communications Gateway subsystem and can be visualized in Process Block 11000. One example of logic flow for this algorithm is shown in FIG. 16A. It can negotiate waveform compatibility using MPC with untrusted coalition nodes and other nodes to enable secure interoperability without data leakage. The gateway can use multi-party computation (MPC) to perform secure waveform and policy negotiation between untrusted or semi-trusted nodes. Local and remote node inputs—such as waveform capabilities, constraints, and mission policies—can be encrypted and processed via secret-sharing logic without exposing raw data. The MPC engine can output a compatibility agreement that enables coalition waveform interoperability while preserving operational security and preventing telemetry leakage.

A twenty-sixth algorithm can enable a failback policy engine. This algorithm can manage pre-negotiated fallback configurations and handle seamless transitions between waveforms or protocols when needed, including when degradation or failure occurs. It can maintain communications with or without operator intervention during contested or congested conditions It is a component of the Continuity Manager subsystem and can be visualized in FIGS. 3E, 3F, 3I and 3O, in Process Blocks 4000, 5000, 8000, and 14000. One example of logic flow for this algorithm is shown in FIG. 16B. It can manage pre-negotiated fallback waveforms and trigger based on link health, enabling actual or near zero-downtime RF transitions under threat or failure. The gateway can monitor waveform performance, link health, and environmental threat indicators to determine when pre-negotiated fallback configurations should be activated. A failback decision engine can use predefined thresholds to autonomously trigger transitions to backup waveforms or protocols with minimal disruption. A seamless transition handler ensures zero or near-zero downtime RF continuity, even under active jamming, interference, or protocol failure.

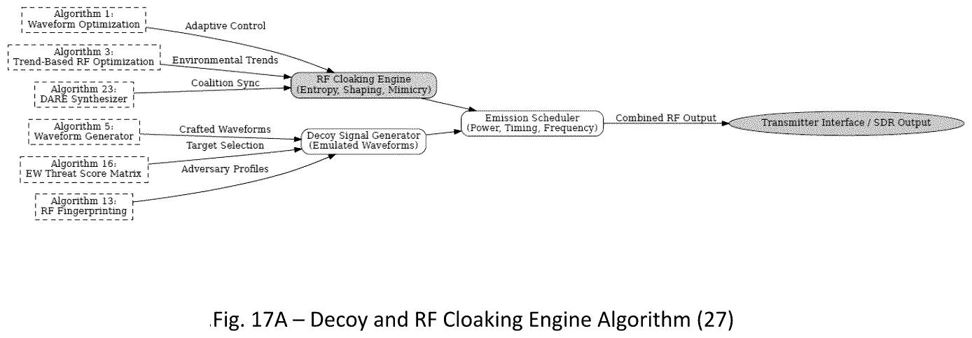

A twenty-seventh algorithm can enable decoy and/or RF cloaking. Example logic for this algorithm is shown in FIG. 17A. The gateway can employ autonomous decoy operations to mislead adversarial RF sensors, signal classifiers, or spectrum surveillance platforms. These operations may include the orchestrated emission of crafted RF signals either derived from known mission-critical waveforms or dynamically synthesized using the self-optimizing waveform engine of FIG. 3F and the example algorithm of FIG. 6A to emulate high-value signal profiles. Decoy content can be disseminated from sub-nodes, payloads, or tactical emitters under adaptive emission schedules that vary timing, frequency, and/or framing to maximize adversary sensor engagement. The decoy strategy is governed by a multi-variable decision layer using the EW Threat Score Matrix of FIG. 3D and the algorithm of FIG. 6B, RF Fingerprinting of FIG. 3I and the example algorithm of FIG. 10A, and real-time Spectrum Analysis of FIG. 3C and the example algorithm of FIG. 6B, enabling mission-prioritized deception that can adapt in real time to evolving threat landscapes.

The gateway can engage in RF cloaking, which is a survivability technique that can obfuscate mission transmissions by blending them into environmental RF noise, spoofing ambient signal patterns, or reducing observable entropy. RF cloaking may leverage waveform shaping, adaptive power modulation, dynamic spectral flattening, and intentional signal mimicry, coordinated by the Adaptive Waveform Optimization Engine of FIGS. 3D, 3E and 3F and the example algorithm of FIG. 4A, and informed by temporal trends identified via Trend-Based RF Optimization of FIGS. 3I and 3O and the example algorithm of FIG. 5A. The cloaking engine supports environment-aware spectral shaping, modifying burst density, entropy profiles, and modulation signatures to match surrounding signal activity and avoid detection. When operating in coalition or denied environments, cloaking profiles may be autonomously synchronized across nodes using the Distributed Adaptive Radio Engine of FIGS. 3L and 3N, and the example algorithm of FIG. 15A, while preserving continuity via the Failback Policy Engine of FIGS. 3E and 3O, and the example algorithm of FIG. 16B. Collectively, these functions form a distributed deception layer that enables secure, resilient operations against advanced spectrum attribution, AI-enabled threat detection, and near-peer jamming platforms.

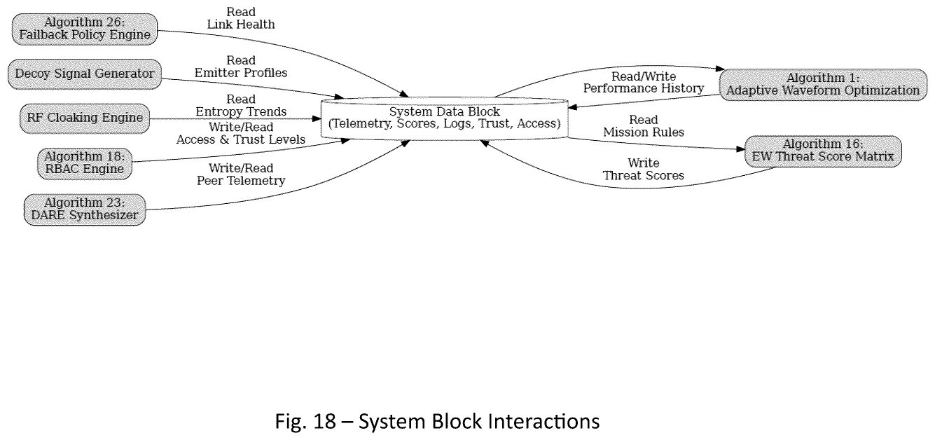

FIG. 18 illustrates example interactions of the above algorithms with the system data blocks of FIG. 3A. FIG. 18 further illustrates the sharing of data among and between the system data blocks to provide coordination and context sharing within the gateway.

Thus, the present gateway solves problems in conventional systems and provides configurable hardware and software that allows the gateway to intelligently adapt to RF environments and to provide solutions not previously available.

Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure.

The order or sequence of any process or method steps may be varied or re-sequenced according to alternative implementations. Other substitutions, modifications, changes, and omissions may be made in the design, operating conditions, and arrangement of the implementations without departing from the scope of the present disclosure. The present disclosure contemplates methods, systems, and programming products on any machine-readable media for accomplishing various operations.

The implementations of the present disclosure may be implemented using existing computer processors, or by a special purpose computer processor for an appropriate system, incorporated for this or another purpose, or by a hardwired system. Implementations within the scope of the present disclosure include programming products including machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps.

“Exemplary” means “an example of” and is not intended to convey an indication of a preferred or ideal implementation. “Such as” is not used in a restrictive sense, but for explanatory purposes. Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed:

1. An adaptive multi-waveform gateway, comprising:
a radio frequency (RF) input module that receives RF signals within in an RF environment and examines characteristics of the RF signals;
a telemetry module that determine telemetry data associated with the received RF signals to evaluate the RF environment;
a decision and adaptation module that determines outgoing RF signaling in accordance with an evaluated RF environment, wherein the outgoing RF signaling is selected from predetermined RF waveforms stored in a waveform repository or a self-generated waveform that is created by the gateway; and
a controller that instructs a software defined radio (SDR) to communicate an RF output in accordance with a selected outgoing RF signaling.

2. The adaptive multi-waveform gateway of claim 1, the RF input further comprising a spectrum analyzer that measures signal amplitude across different frequencies to identify and parse incoming signals, interference, and other RF activity.

3. The adaptive multi-waveform gateway of claim 2, wherein metrics associated with the received RF signals are extracted to assess a quality of the received RF signals in the RF environment, and
wherein the metrics include at least one of signal-to-noise ratio (SNR), bit error rate (BER), received signal strength indicator (RSSI), and noise levels.

4. The adaptive multi-waveform gateway of claim 3, wherein the decision and adaptation module further comprises a machine learning module to determine preferred or optimal waveforms from the metrics.

5. The adaptive multi-waveform gateway of claim 4, wherein the decision and adaptation module determines the preferred or optimal waveforms in real-time while introducing minimal latency.

6. The adaptive multi-waveform gateway of claim 1, wherein the telemetry module determines time-series data to identify patterns, trends, and relationships to forecast future values.

7. The adaptive multi-waveform gateway of claim 1, wherein the telemetry module determines event triggers to initiate actions the gateway detects that a predetermined event has occurred.

8. The adaptive multi-waveform gateway of claim 1, wherein the decision and adaptation module is trained to use knowledge of the RF environment to select the outgoing RF signaling.

9. The adaptive multi-waveform gateway of claim 1, wherein the decision and adaptation module performs an assessment of RF waveforms to score the RF waveforms relative to each other, and identifies optimal or quasi-optimal RF waveforms for use in the RF environment.

10. The adaptive multi-waveform gateway of claim 1, wherein the decision and adaptation module provides signed and validated RF waveforms for use by the SDR for output from the gateway.

11. The adaptive multi-waveform gateway of claim 1, further comprising a self-optimizing waveform generator that synthesizes waveforms based on environmental feedback and historical success rates.

12. The adaptive multi-waveform gateway of claim 1, wherein the gateway is adapted to autonomously respond to electronic warfare (EW) threats, by identifying, classifying, and prioritizing EW threats,
wherein the EW threats include at least one of jamming, spoofing, and an anomalous patterns.

13. The adaptive multi-waveform gateway of claim 12, wherein the gateway responds by implementing decoying, spectral masking, frequency hopping, notch filtering, waveform switching, or geolocation cueing.

14. The adaptive multi-waveform gateway of claim 1, wherein the RF output is an encrypted RF waveform.

15. The adaptive multi-waveform gateway of claim 1, further comprising a modular architecture that enables updating of individual modules that comprise the modular architecture without disrupting operation of the gateway.

16. The adaptive multi-waveform gateway of claim 1, further comprising a distributed adaptive radio engine (DARE) to share waveform performance, threat telemetry, and learned optimizations.

17. The adaptive multi-waveform gateway of claim 1, further comprising a tiered RF failback with pre-negotiated continuity to provide for a multi-tiered RF continuity protocol that pre-negotiates waveform transitions across multiple gateways.

18. The adaptive multi-waveform gateway of claim 1, further comprising a Multi-Party Computation (MPC) mode that enables joint computation of waveform compatibility, routing decisions, or interference response strategies without revealing sensitive internal models or telemetry.

19. In an adaptive multi-waveform gateway comprising a radio frequency (RF) input module, a telemetry module, a decision and adaptation module, and a controller that instructs a software defined radio (SDR), a method comprising:
receiving RF signals within an RF environment;
examining characteristics of the RF signals;
determining telemetry data associated with the RF signals to evaluate the RF environment;
determining outgoing RF signaling from predetermined RF waveforms stored in a waveform repository in accordance with an evaluated RF environment or from a self-generated waveform created by the gateway; and
instructing the software defined radio (SDR) to communicate an RF output in accordance with a selected outgoing RF signaling.

20. The method of claim 19, further comprising measuring a signal amplitude across different frequencies using a spectrum analyzer to identify and parse incoming signals, interference, and other RF activity.

21. The method of claim 20, further comprising:
extracting metrics associated with the received RF signals to assess a quality of the received RF signals in the RF environment,
wherein the metrics include at least one of signal-to-noise ratio (SNR), bit error rate (BER), received signal strength indicator (RSSI), and noise levels.

22. The method of claim 21, further comprising using machine learning to determine preferred or optimal waveforms from the metrics.

23. The method of claim 22, further comprising determining the preferred or optimal waveforms using the telemetry module in real-time while introducing minimal latency.

24. The method of claim 19, further comprising determining time-series data using the telemetry module to identify patterns, trends, and relationships to forecast future values.

25. The method of claim 19, further comprising determining event triggers using the telemetry module to initiate actions the gateway detects that a predetermined event has occurred.

26. The method of claim 19, further comprising training the decision and adaptation module to use knowledge of the RF environment to select the outgoing RF signaling.

27. The method of claim 19, further comprising:
performing an assessment of RF waveforms by the decision and adaptation module to score the RF waveforms relative to each other; and
identifying optimal or quasi-optimal RF waveforms for use in the RF environment.

28. The method of claim 19, further comprising providing signed and validated RF waveforms for use by the SDR for output from the gateway.

29. The method of claim 19, further comprising further comprising synthesizing waveforms based on environmental feedback and historical success rates.

30. The method of claim 19, further comprising autonomously responding, by the gateway, to electronic warfare (EW) threats, by identifying, classifying, and prioritizing EW threats, wherein the EW threats include at least one of jamming, spoofing, and an anomalous patterns.

31. The method of claim 30, further comprising responding the EW threats by implementing decoying, spectral masking, frequency hopping, notch filtering, waveform switching, or geolocation cueing.

32. The method of claim 19, further comprising outputting an encrypted RF waveform.

33. The method of claim 19, further comprising providing the gateway as a modular architecture that enables updating of individual modules that comprise the modular architecture without disrupting overall functions of the gateway.

34. The method of claim 19, further comprising sharing waveform performance, threat telemetry, and learned optimizations with other communicatively connected gateways using a distributed adaptive radio engine (DARE).

35. The method of claim 19, further comprising using a multi-tiered RF continuity protocol that pre-negotiates waveform transitions across multiple gateways to provide a tiered RF failback with pre-negotiated continuity.

36. The method of claim 19, further comprising providing joint computation of waveform compatibility, routing decisions, or interference response strategies without revealing sensitive internal models or telemetry in a Multi-Party Computation (MPC) mode.
